(19) United States
(12) Patent Application Publication
(10) Pub. No.: US 2021/0258275 A1
(43) Pub. Date: Aug. 19, 2021

(54) LOW LATENCY MESSAGING SERVICE FOR THE 5GC

(71) Applicant: CONVIDA WIRELESS, LLC, Wilmington, DE (US)

(72) Inventors: Michael F. STARSINIC, Newtown, PA (US); Rocco DI Girolamo, Laval (CA); Hongkun LI, Malvern, PA (US); Catalina Mihaela MLADIN, Hatboro, PA (US)

(21) Appl. No.: 17/265,301

(22) PCT Filed: Aug. 2, 2019
(86) PCT No.: PCT/US2019/044921

§ 371 Date: Feb. 2, 2021

Related U.S. Application Data
(60) Provisional application No. 62/714,262, filed on Aug. 3, 2018.

(51) Int. Cl. H04L 12/58; H04L 29/08; H04W 4/12

(52) U.S. Cl. CPC H04L 51/28; H04L 51/38; H04W 4/12; H04L 67/12

(57) ABSTRACT

Methods and apparatuses are described herein for sending and receiving messages using a low latency messaging service, referred to herein as a 5GMSG service, which resides in the 5G core network (5GC). In accordance with one embodiment, an apparatus may send, to a second apparatus, a first message comprising a first identifier for a third apparatus to enable the third apparatus to receive the first message. The apparatus may receive, from the second apparatus, a second message comprising a second identifier of the third apparatus. The apparatus may send, to the third apparatus, a third message comprising the second identifier. The first identifier may comprise an external public identifier of the third apparatus. The second identifier may comprise a 5G Globally Unique Temporary Identifier, a 5G Temporary Mobile Subscriber Identity (5G-TMSI), or a hashed version of a 5G-TMSI. The apparatus may receive notifications indicating that the second identifier changed.

### CROSS-REFERENCE TO RELATED APPLICATIONS

This application claims the benefit of U.S. Provisional Patent Application No. 62/714,262, filed Aug. 3, 2018, which is hereby incorporated by reference in its entirety.

### BACKGROUND

3GPP Device-to-Device (ProSe) communication may comprise direct communication between two UEs and group based communication among UEs. This type of communication may include very low latency.

However, there is no core network involvement when devices send messages directly to each other. The core network may not be able to observe each message, charge for each message, ensure delivery, etc. Also, the devices need to be in proximity of each other in order to communicate. Since user plane traffic has to flow through PDU sessions, communication paths that traverse the core network are generally higher in latency and are often not suitable for applications that require low latency. Examples of types of applications that require low latency are gaming, robotics, assembly line control, and virtual reality. Accordingly, there is a need for improved low latency messaging services for 5G systems.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to limitations that solve any or all disadvantages noted in any part of this disclosure.

Methods and apparatuses are described herein for sending and receiving messages using a low latency messaging service, referred to herein as a 5GMSG service, which resides in the 5G core network (5GC). The embodiments described herein are directed procedures between the UE and 5GMSG service using certain UE identifiers to enable the 5GC (i.e. the 5GMSG service) to quickly route messages to a recipient UE, thus achieving low latency

In accordance with one embodiment, an apparatus may send, to a second apparatus, a first message comprising a first identifier for a third apparatus to enable the third apparatus to receive the first message. The apparatus may receive, from the second apparatus, a second message comprising a second identifier of the third apparatus. The apparatus may send, to the third apparatus, a third message comprising the second identifier. The apparatus may comprise a user equipment (UE). The second apparatus may comprise a network function such as an access and management function (AMF). The third apparatus may comprise a user equipment (UE) or an Internet of Things (IoT) server. The first identifier may comprise an external public identifier of the third apparatus. The second identifier may comprise a 5G Globally Unique Temporary Identifier, a 5G Temporary Mobile Subscriber Identity (5G-TMSI), or a hashed version of a 5G-TMSI. The apparatus may receive messages, such as non-access stratum notification messages, indicating that the second identifier has changed (e.g., based on a location change of the third apparatus). A protocol data unit (PDU) session may be established by the apparatus prior to sending the first message.

### BRIEF DESCRIPTION OF THE DRAWINGS

In order to facilitate a more robust understanding of the application, reference is now made to the accompanying drawings, in which like elements are referenced with like numerals. These drawings should not be construed to limit the application and are intended only to be illustrative.

FIG. 1 is a diagram of an example 5G PDU session establishment procedure;

FIG. 2 is a diagram of an example 5GMSG protocol stack for the control plane;

FIG. 3 is a diagram of an example session less MO 5GMSG control plane procedure for use by a UE for sending data to a 5GMSG service;

FIG. 4 is a diagram of an example session less MT 5GMSG control plane procedure (push) for use by the 5GMSG to send data to a UE or a group of UEs;

FIG. 5 is a diagram of an example session less MT 5GMSG control plane procedure (pull) for use by the 5GMSG service to send data to a UE or a group of UEs;

FIG. 6 is a diagram of an example 5GMSG protocol stack (user plane), which depicts how the 5GMSG service may communicate with UEs in the 5G system;

FIG. 7 is a diagram of an example session less MO 5GMSG user plane procedure for use by a UE to send data to the 5GMSG service via a user plane connection;

FIG. 8 is a diagram of an example session less MT 5GMSG user plane procedure (push and pull) for use by a UE to send data to the 5GMSG service via a user plane connection;

FIG. 9 is a diagram of an example graphical user interface (GUI) that a UE may display for configuring the 5GMSG service;

FIG. 10A illustrates an example communications system;

FIG. 10B is a system diagram of an example RAN and core network;

FIG. 10C is a system diagram of another example RAN and core network;

FIG. 10D is a system diagram of another example RAN and core network;

FIG. 10E illustrates another example communications system;

FIG. 10F is a block diagram of an example apparatus or device, such as a wireless transmit/receive unit (WTRU); and

FIG. 10G is a block diagram of an exemplary computing system.

### DETAILED DESCRIPTION OF ILLUSTRATIVE EMBODIMENTS

Methods and apparatuses are described herein for sending and receiving messages among UEs and IoT Servers using a low latency messaging service, referred to herein as a 5GMSG service, which resides in the 5G core network (5GC). The embodiments described herein are directed procedures between the UE and 5GMSG service using certain UE identifiers to enable the 5GC (i.e. the 5GMSG service) to quickly route messages to a recipient UE, thus achieving low latency and enabling the messages to interact with the 5GC (to enable features such as charging and lawful intercept). Examples of types of applications that require low latency are gaming, robotics, assembly line control, and virtual reality

In one embodiment, a UE may send a message using a public identifier and receive from the network an identifier of the message recipient (e.g., the recipient's 5G-GUTI). The recipient's 5G-GUTI may then be used by the sending UE as the identifier of the recipient for subsequent messages without again requesting identifier information from the network and thus enabling low latency.

The following is a list of acronyms relating to technologies that may be used in the examples described herein:

| | |
|---|---|
| 5GC | 5G Core Network |
| 5G-GUTI | 5G Globally Unique Temporary Identifier |
| 5GMSG | 5G Messaging Service |
| 5G-S-TMSI | 5G SAE-Temporary Mobile Subscriber Identity |
| 5G-TMSI | 5G Temporary Mobile Subscriber Identity |
| AF | Application Function |
| AMF | Access and Management Function |
| AN | Access Network |
| API | Application Programmer Interface |
| AS | Application Server |
| DM | Device Management |
| DN | Data Network |
| GTP | GPRS Tunneling Protocol |
| GUAMI | Globally Unique AMF Identifier |
| MM | Mobility Management |
| MO | Mobile Originated |
| NAS | Non-Access Stratum |
| NEF | Network Exposure Function |
| NF | Network Function |
| MCC | Mobile Country Code |
| MNC | Mobile Network Code |
| MT | Mobile Terminated |
| OMA | Open Mobile Alliance |
| PCF | Policy and Charging Function |
| PDU | Protocol Data Unit |
| P-GW | PDN Gateway |
| ProSe | Proximity Services |
| (R)AN | Radio Access Network |
| SAE | System Architecture Evolution |
| SCEF | Service Capability Exposure Function |
| SCS/AS | Service Capability Server/Application Server |
| SIM | Subscriber Identity Module |
| SM | Session Management |
| SMF | Session Management Function |
| UPF | User Plane Function |
| UDM | User Data Management |
| UDR | User Data Repository |
| UE | User Equipment |

5G systems have requirements and use cases that call for low latency and high reliability. Scenarios that require low latency and high reliability include but are not limited to Motion Control, Discrete Automation, Process Automation, Automation for Electricity Distribution, Intelligent Transport Systems, Tactile Internet, and Remote Control.

Scenarios such as Tactile Internet may require relatively low traffic data rates and small payloads, and scenarios such as process automation may require relatively high traffic data rates and large payloads.

For example, a messaging service for the 5G system referred to as 5GMSG may be relevant to the following communication models:

MOMT: UE A sends a message to UE B

MOAT: UE A sends a message to Application Server

AOMT: Application Server sends a message to UE A

MOMT-G: UE A sends a message to a group of UEs

AOMT-G: Application Server sends a message to a group of UEs

AOMT-B: Application Server broadcast a message to all UEs (for example, in a specific service area)

In another example, a 5GMSG proxy/gateway may comprise a node that may realize the interworking between 5G MSG and M2M system or access of 5G IoT devices.

One identifier used in 5G systems is the 5G Globally Unique Identifier (5G-GUTI) that contains several sub-identities, including the serving AMF and the assigned 5G-TMSI (temporary ID). The 5G-GUTI may be structured as:
<5G-GUTI>:=<GUAMI><5G-TMSI>

where the Globally Unique AMF Identifier (GUAMI) may identify the assigned AMF and 5G-TMSI may identify the UE uniquely within the AMF.

The Globally Unique AMF ID (GUAMI) may be structured as:
<GUAMI>:=<MCC><MNC><AMF Region ID><AMF Set ID><AMF Pointer>

where the AMF Region ID may identify the region, the AMF Set ID may uniquely identify the AMF Set within the AMF Region, and AMF Pointer may uniquely identify the AMF within the AMF Set.

The AMF Region ID may address the case that there are more AMFs in the network than the number of AMFs that can be supported by AMF Set ID and AMF Pointer by enabling operators to re-use the same AMF Set IDs and AMF Pointers in different regions.

The 5G-S-TMSI may be the shortened form of the GUTI to enable more efficient radio signaling procedures (e.g. during Paging and Service Request) and may be defined as:
<5G-S-TMSI>:=<AMF Set ID><AMF Pointer><5G-TMSI>

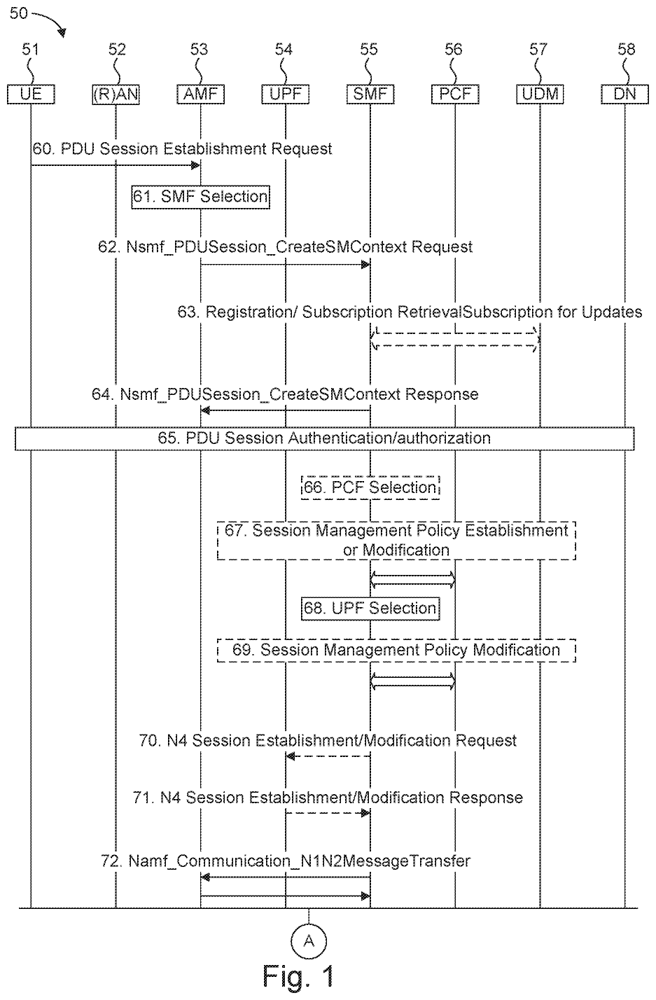

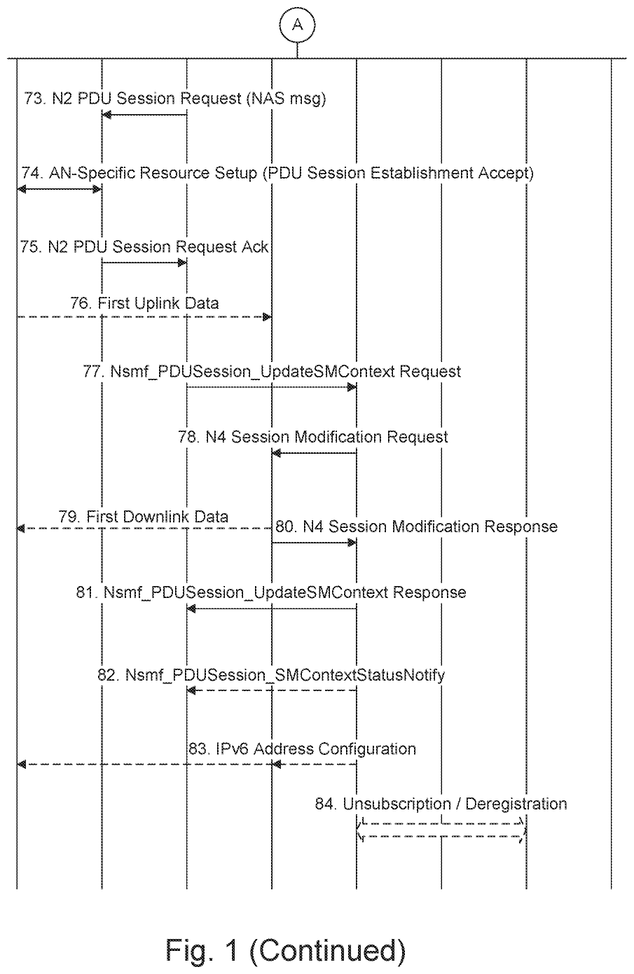

FIG. 1 is a diagram of an example 5G PDU session establishment procedure 100, which may be used in the 5GC to establish a session between the UE and a UPF. A PDU session may comprise an association between the UE and a Data Network that provides exchange of PDUs between a UE and a Data Network. Within the core network, a PDU session is made up of GTP tunnels between the Access Network (AN) node and the UPFs that are part of the PDU session. User plane traffic to/from a UE flow inside these tunnels are set-up during the PDU session establishment procedure 100.

Referring to FIG. 1, UE 51 may send, via (R)AN 52, a PDU establishment request to AMF 53 (step 60). AMF 53 may select an SMF (step 61). AMF 53 may send an Nsmf_PDUSession_CreateSMContext request to the selected SMF, SMF 55 (step 62). SMF 55 and UDM 57 may perform registration/subscription for updates (step 63). SMF 55 may send an Nsmf_PDUSession_CreateSMContext response AMF 53 (step 64). PDU session authentication/authorization may be performed (step 65). SMF 55 may perform PCF selection (step 66). SMF 55 and the selected PCF, PCF 56, may perform session management policy establishment or modification (step 67). SMF 55 may perform UPF selection (step 68). SMF 55 and PCF 56 may perform session management policy modification (step 69). SMF 55 may send an N4 session establishment/modification request to UPF 54 (step 70). UPF 54 may send an N4 session establishment/modification response to SMF 55 (step 71). SMF 55 and AMF 53 may perform Namf_Communication_N1N2MessageTransfer (step 72). AMF 53 may send an N2 PDU session request (NAS msg) to (R)AN 102 (step 73). UE 51 and (R)AN 52 may perform AN-specific resource setup (PDU establishment acceptance) (step 74). (R)AN 52 may send an N2 PDU session request acknowledgment (step 55). UE 51 may send first uplink data to UPF 54 (step 76). AMF 53 may send an Nsmf_PDUSession_UpdateSMContext request to SMF 55 (step 77). SMF 55 may send an N4 session modification request to UPF 54 (step 78). UPF 54 may send first downlink data to UE 51 (step 79). UPF 54 may send an N4 session modification response to SMF 55 (step 80). SMF 55 may send an Nsmf_PDUSession_UpdateSMContext response to AMF 53 (step 81). SMF 55 may send an Nsmf_PDUSession_SMContextStatusNotify to AMF 53 (step 82). SMF 55 may configure the IPv6 address of UE 51 (step 83). SMF 55 and UDM 57 may perform unsubscription/deregistration (step 84).

As described above, 3GPP Device-to-Device (ProSe) communication may comprise direct communication between two UEs and group based communication among UEs and may require very low latency. However, there is no core network involvement when devices send messages directly to each other, and the core network may not be able to observe each message, charge for each message, ensure delivery, etc. For example, the network may only be able to assist with discovery and authorize usage of the spectrum. Also, the devices need to be in proximity of each other in order to communicate.

Since user plane traffic has to flow through PDU sessions, communication paths that traverse the core network are generally higher in latency. For example, IP packets may need to be routed to the edge of the network (i.e. to a UPF or P-GW) and may then be routed to the destination node via IP. A similar problem exists if non-IP NAS messaging is used. Data may need to be routed to the edge of the network (i.e. to the SCEF) and may then be sent to the SCS/AS. In both examples, if the data needs to be routed to another UE, the data may need to be sent back through the network edge and towards the destination node. Thus, this type of messaging is often not suitable for applications that require low latency. Examples of types of applications that require low latency are gaming, robotics, assembly line control, and virtual reality.

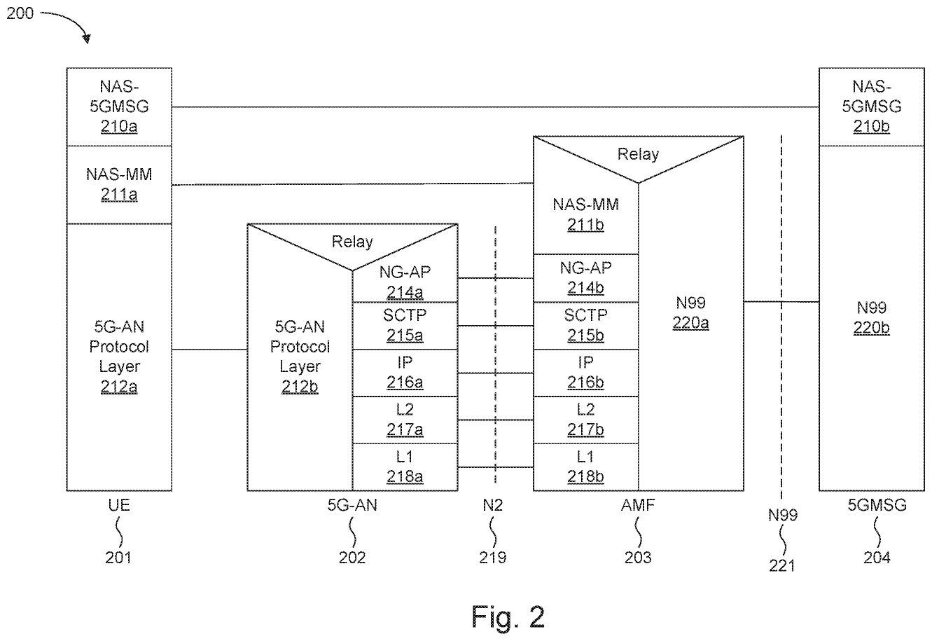

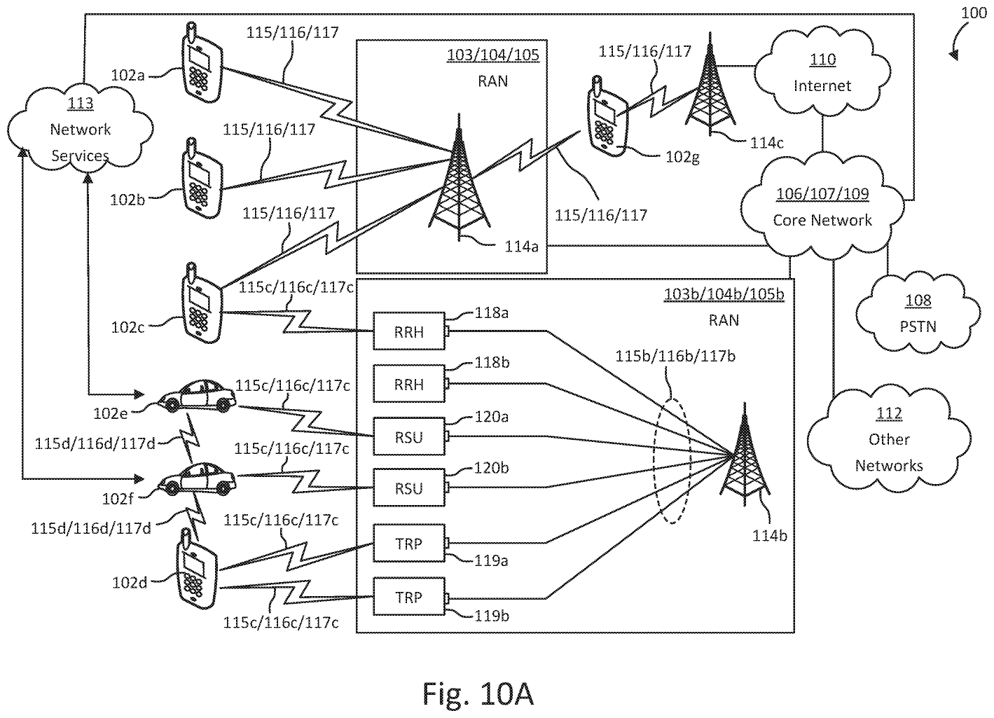

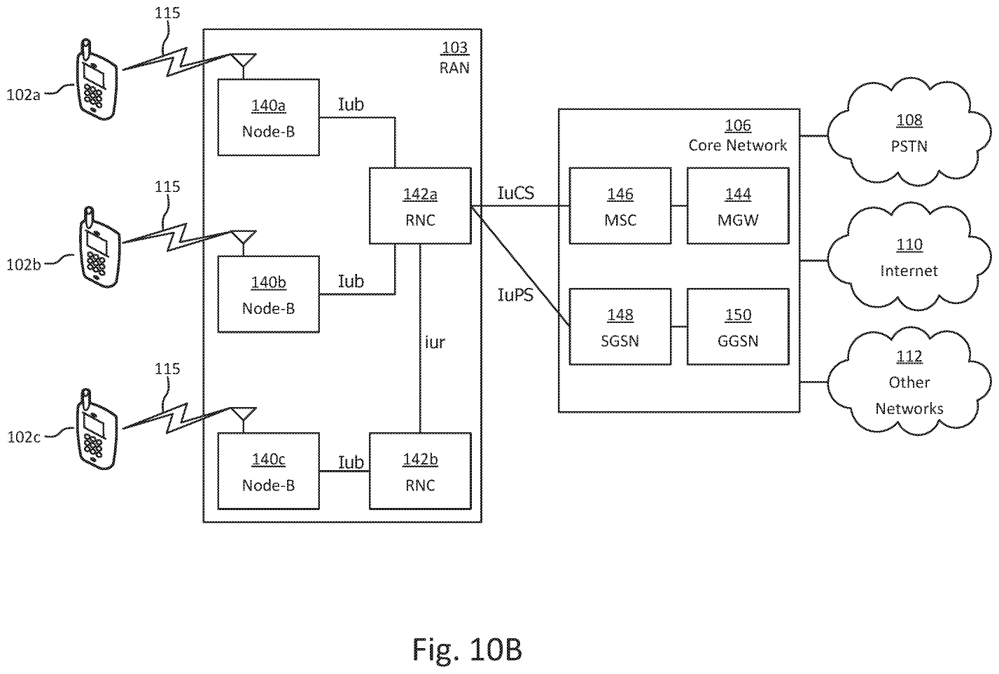

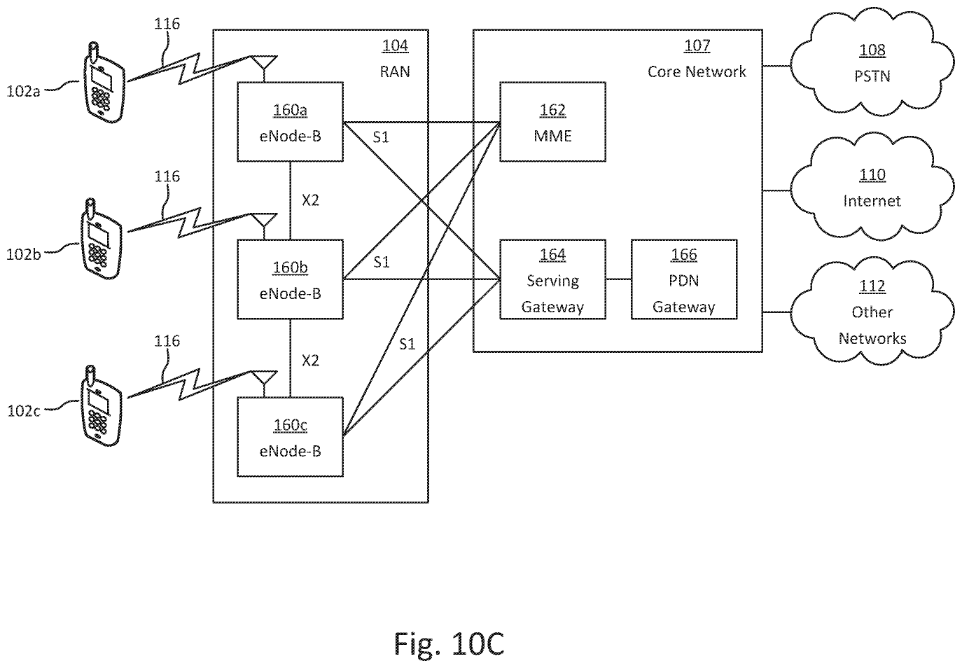

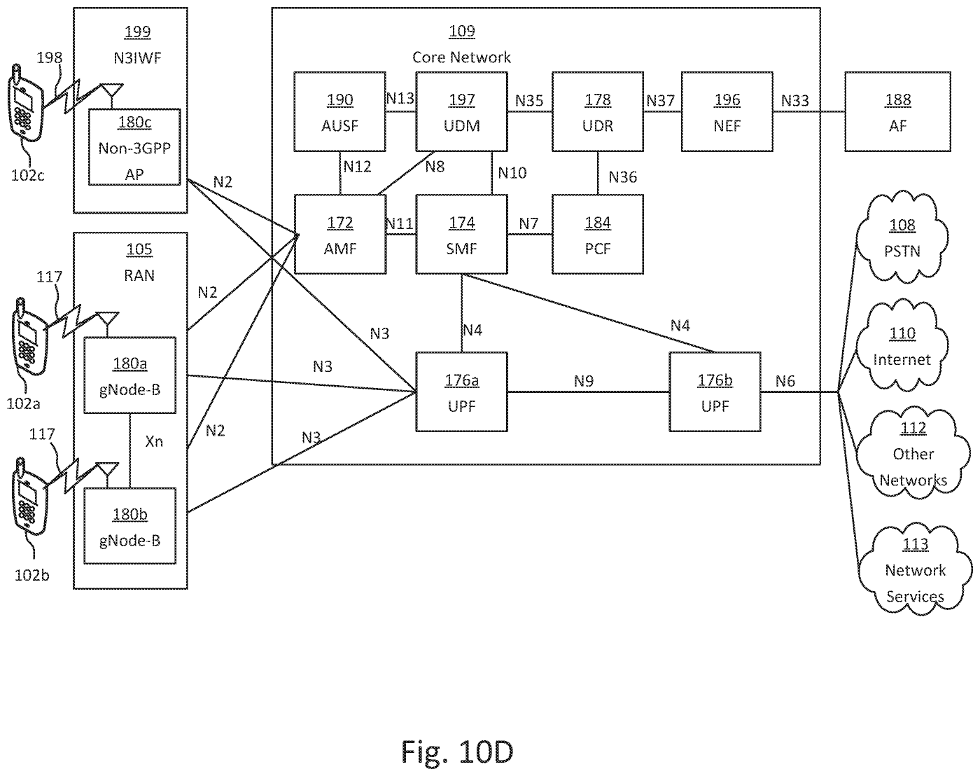

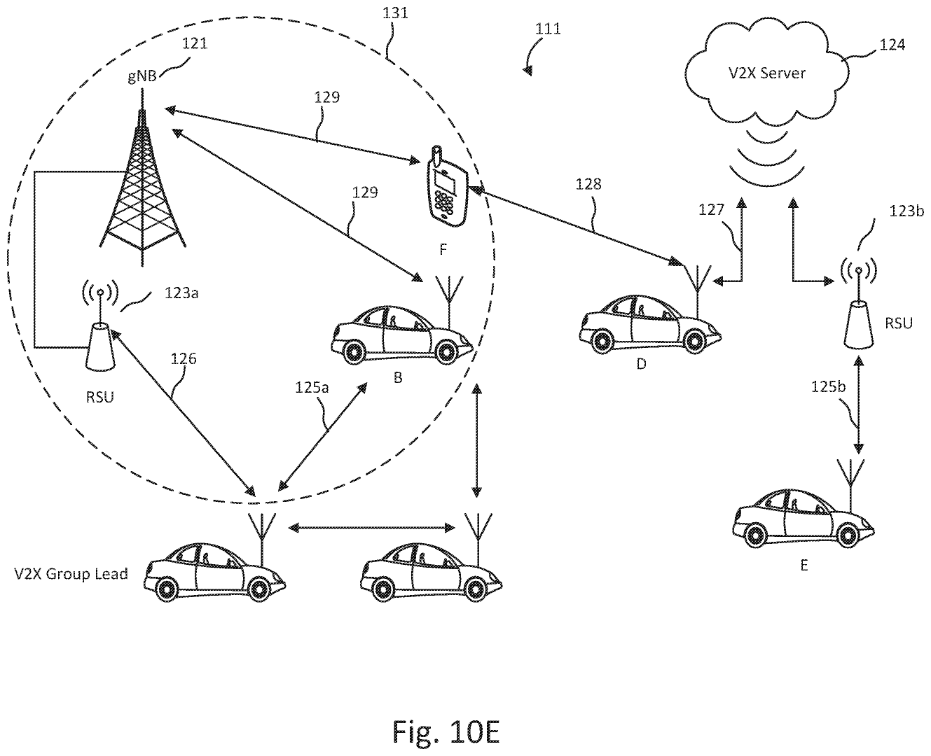

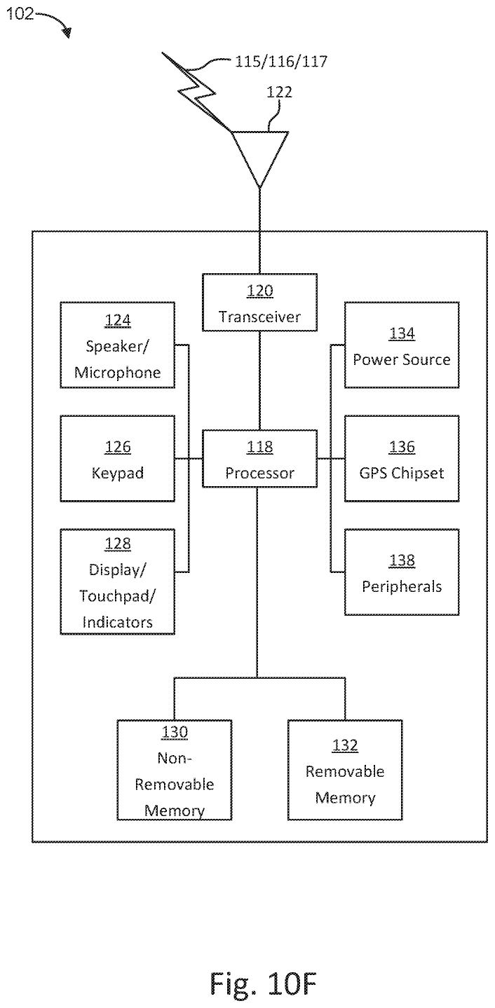

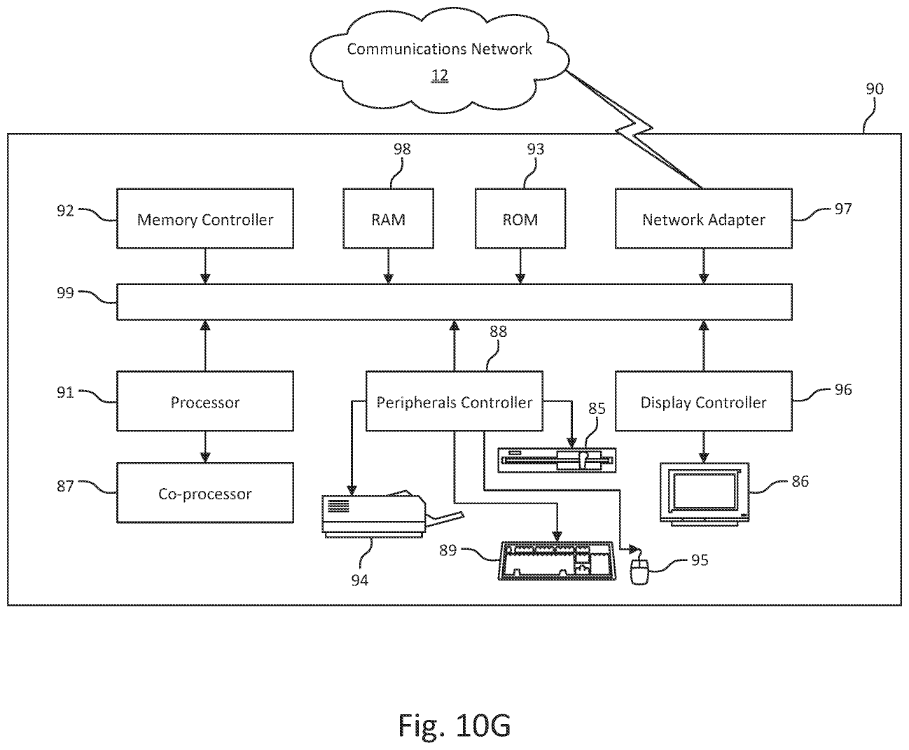

Methods and apparatuses are described herein for supporting low latency communication and group communication. FIGS. 2 to 9 (described hereinafter) illustrate various embodiments associated with supporting low latency communication and group communication. In these figures, various steps or operations are shown being performed by one or more nodes, apparatuses, devices, servers, functions, or networks. For example, the apparatuses may operate singly or in combination with each other to effect the methods described herein. As used herein, the terms apparatus, network apparatus, node, server, device, entity, network function, and network node may be used interchangeably. It is understood that the nodes, devices, servers, functions, or networks illustrated in these figures may represent logical entities in a communication network and may be implemented in the form of software (e.g., computer-executable instructions) stored in a memory of, and executing on a processor of, a node of such network, which may comprise one of the architectures illustrated in FIGS. 10A or 10B described below. That is, the methods illustrated in FIGS. 2 to 9 may be implemented in the form of software (e.g., computer-executable instructions) stored in a memory of a network node, such as for example the node or computer system illustrated in FIGS. 10C or 10D, which may store computer-executable instructions, when executed by a processor of the node, that perform the steps illustrated in the figures. It is also understood that any transmitting and receiving steps illustrated in these figures may be performed by communication circuitry (e.g., circuitry 34 or 97 of FIGS. 10C and 10D, respectively) of the node under control of the processor of the node and the computer-executable instructions (e.g., software) that it executes. It is further understood that the nodes, devices, and functions described herein may be implemented as virtualized network functions.

The embodiments described herein may implement the low latency messaging service, 5GMSG, which resides in the 5G core network. The embodiments described herein may be directed to UE interaction with 5GMSG in order to send messages to other UEs. The 5GMSG may also be used to send and receive messages to and from an IoT Server.

GMSG has been designed primarily to support use cases that involve low latency messaging. However, it can also support cases where message recipients are in a sleep mode and not available to receive a message when one is sent to it. For example, this may occur if the device is sleeping. Pull and Push communication models are described herein where the UE may wake up and query the 5GMSG service to determine whether any messages need to be sent to it, or the network may page the UE in order to send it a message

The embodiments described herein may also include use of certain UE identifiers to enable the 5GC (i.e. the 5GMSG) to quickly route messages to the recipient UE, thus achieving low latency for procedures between the UE and 5GMSG.

The advantage of using a session based approach is that the SMF will only need to authorize the session one-time and existing SMF frameworks for maintaining session information may be re-used. However, the disadvantage is that the UE and SMF will need to execute the session establishment procedure and continuously manage the session (e.g., UPF relocation, session context update). If the UE infrequently needs to send messages with low latency, then this session would need to be maintained in anticipate of some future low latency message.

The session based embodiments described herein may define UE interaction with the 5GC (for example, the SMF) to establish the 5GMSG session. A 5GMSG session may rely on transport tunnels (for example, GTP) between the 5G AN and the 5GMSG.

FIG. 2 is a diagram of an example 5GMSG protocol stack for the control plane 200, which may be used in any of the embodiments described herein. As shown in the example protocol stack of FIG. 2, the 5GMSG service may communicate with UEs in the 5G system, and communication between UE 201 and 5GMSG service 204 may be carried on top of NAS-MM signaling. Communication between UE 201 and 5GMSG service 204 may use a NAS protocol referred to as NAS-5GMSG 210a, 210b. In this example, the 5G-GUTI may be used to identify the recipient so that the message can be quickly routed. The 5GMSG functionality may be part of another network function (NF), such as AMF 203. If it is part of AMF 203, then NAS-5GMSG functionality may be part of the NAS-MM protocol.

Referring to FIG. 2, UE 201 may communicate with 5GMSG 204 via the NAS-5GMSG protocol 210a, 201b. UE 201 may communicate with a relay operating as AMF 203 via NAS-MM protocol 211a, 211b. UE 201 may communicate with a relay operating as 5G-AN 202 via the 5G-AN protocol layer 212a, 212b. The relay operating as 5G-AN 202 and the relay operating as AMF 203 may communicate over the N2 interface 219 via NG-AP protocol 214a, 214b; SCTP protocol 215a, 215b; Internet Protocol (IP) 216a, 216b; L2 protocol 217a, 217b; and L1 protocol 218a, 218b. The relay operating as AMF 203 and may communicate with 5GMSG 204 over the N99 interface 221 via the N99 protocol 220a, 220b.

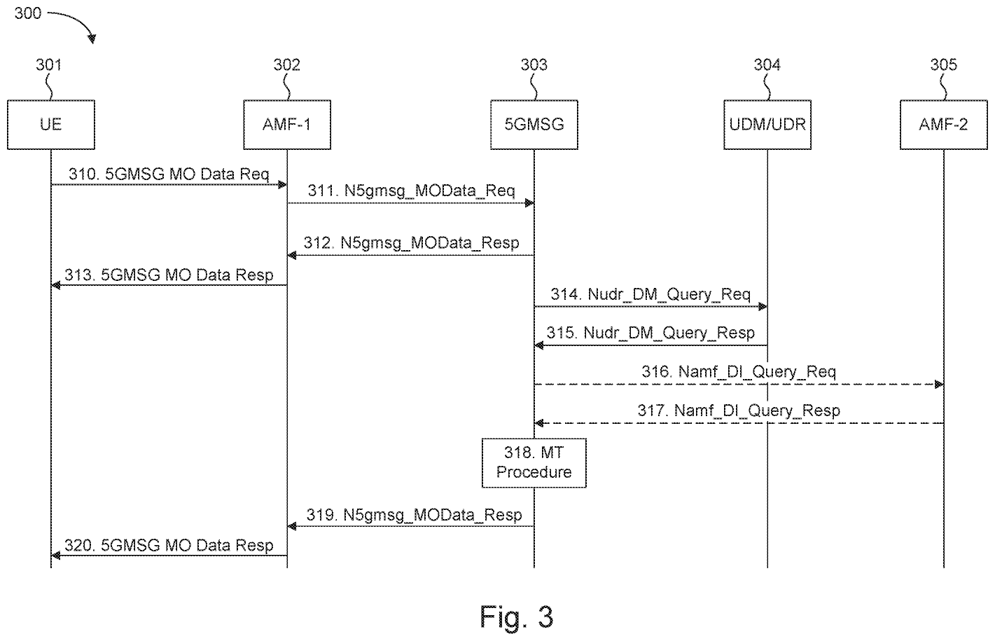

FIG. 3 is a diagram of an example procedure 300 for use by a UE for sending data to a 5GMSG service in a session less communication model, which may be used in any of the embodiments described herein. The 5GMSG service may be an NF or functionality within an NF. The data may be addressed to a single UE, a group of UEs, or an Application Function. In the example procedure 300 of FIG. 3, UE 301 may send a message using a public identifier and receive from the network an identifier of the message recipient (e.g., the recipient's 5G-GUTI), which may then be used by the sending UE 301 as the identifier of the recipient for subsequent messages without again requesting identifier information from the network and thus enabling low latency.

Referring to FIG. 3, an application on UE 301 may invoke an API to cause the UE to send data to the 5GMSG Service, for example by sending a 5GMSG MO Data Req to AMF-1 302 (step 310). The data may be addressed to application(s) that are hosted on other UE(s) or an Application Function. UE 301 may not know the recipient's 5G-GUTI yet. The data may be part of a NAS-5GMSG message that is sent on top of NAS-MM. The NAS-5GMSG may include information elements including but not limited to:

Message Payload: the message payload may comprise data that was provided when the UE application invoked the API.

Message Payload Type: the message payload type may comprise an indication of the message type. The message may comprise data, an acknowledgement, an acknowledgment and data, or a ping message. The purpose of a ping message may be to ensure that the UE has the recipient UE's current 5G-GUTI and that the recipient UE is reachable.

5GMSG Service ID: the 5GMSG Service ID may comprise an identity of a 5GMSG Service or an identity that the network may use to resolve to a 5GMSG Service NF. The value may be provided by the UE application when it invokes the API, the value may be provisioned in the UE (e.g. in the SIM card and/or via OMA DM procedures), or the value may have been received by the UE in an earlier NAS or broadcast message.

Recipient ID: the Recipient ID may comprise an Application Function ID or Data Network Name. The Recipient ID may comprise a UE ID. The UE ID may comprise an External Identifier, a 5G-GUTI, a 5G-S-TMSI, or a 5G-TMSI. The Recipient ID may comprise a Group ID. The Group ID may comprise an External Group Identifier, a GUAMI, AMF Region ID, AMF Set ID, and/or AMF Pointer. Multiple Recipient IDs may be included. For example, a 5G-GUTI and an External ID may be included. The 5GMSG may attempt to send the message with the 5G-GUTI, or part of the 5G-GUTI. If the 5G-GUTI is not up to date, or valid, it may fall back to attempting to send the message with the External Identifier. The 5G-GUTI may also be used to address the recipient while the External Identifier may be used to authorize the operation and confirm that the message is sent to the correct recipient.

Recipient ID Assistance Info: the Recipient ID Assistance Info field may carry the recipient's expected GUAMI, or parts of the GUAMI such as the AMF Region ID, AMF Set ID, or AMF Pointer. This information may be used to help the 5GMSG route the message to the recipient more quickly. The network may provide the UE with the recipient's 5G-GUTI, which may contain the GUAMI.

Recipient Application ID: the Recipient Application ID may comprise an identifier that is used by the recipient UE(s) to route the message payload to the appropriate Application on the UE or used by the recipient AF to route the message payload to the appropriate Application, SCS/AS, or AS.

Sender ID: the Sender ID may comprise a UE ID. The UE ID may be an External Identifier, a 5G-GUTI, a 5G-S-TMSI, or a 5G-TMSI. Multiple UE IDs may be provided (for example, the External Identifier and 5G-S-TMSI). The Sender ID may comprise a specific identifier that is associated with the UEs using the 5GMSG Service

Sender Application ID: the Sender Application ID may comprise an identifier that is used to identify the application on the sending UE that initiated the message. The recipient application may use this identifier when sending messages (i.e. replies) to the sending application.

Acknowledgment Preference: the Acknowledgment Preference field may indicate whether the sender wants an acknowledgement. The Acknowledgment Preference field may also indicate whether the acknowledgement is to be sent when the message reaches the 5GMSG, when 5GMSG locates the recipient, when the 5GMSG sends the message to the recipient's serving AMF, or when the 5GMSG receives an acknowledgment from the recipient.

Referring to FIG. 3, AMF-1 302 may use the 5GMSG Service ID to select a 5GMSG NF. The AMF may use the 5GMSG Service ID, recipient ID, and/or sender ID to query the NRF and obtain the NF ID of the 5GMSG NF. AMF-1 302 may then forward the NAS-5GMSG message that was received in step 310 to the 5GMSG, referred to in FIG. 3 as a N5gmsg_MOData_Req sent to 5GMSG service 303 (step 311). This step may be considered 5GMSG selection and is further described below.

Depending on the indicated Acknowledgment Preference, the 5GMSG service 303 may respond to the UE with a NAS-5GMSG message that includes an indication of whether or not the message was accepted for delivery, by sending a N5gmsg_MOData_Resp sent to AMF-1 302 (step 312).

AMF-1 302 may then forward the NAS-5GMSG message that was received in step 312 to UE 301, referred to in FIG. 3 as a 5GMSG MO Data Resp sent to UE 301 (step 313).

The purpose of steps 314 and 315 includes obtaining the identity of the AMF-2 that is serving the recipient UE(s) so that the message can be sent to the AMF (e.g., AMF-1 302) that serves the recipient UE(s). Steps 314 and 315 may be skipped if the message of step 311 included the recipient's 5G-TMSI, GUAMI(s), or Recipient ID Assistance Info that may be used to determine to which AMF to forward the message.

5GMSG service 303 may invoke the Nudr_DM_Query service and may send a Nudr_DM_Query_Req to UDM/UDR 304 (step 314). If the message that was received in step 311 includes an External Identifier, then the 5GMSG NF may provide the External Identifier at step 314, along with an indication that the 5GMSG is requesting information associated with the UE's GUAMI (or part of the UE's GUAMI). If the message that was received in step 311 includes an External Group Identifier, then the 5GMSG NF may provide the External Group Identifier at step 314, along with an indication that the 5GMSG service requests information associated with the GUAMI(s) that are associated with the group.

UDM/UDR 304 may determine whether UE 301 is authorized to use the 5GMSG service and is authorized to send a 5GMSG message to the recipient. If the authorization is successful, UDM/UDR 304 replies to the invocation of the Nudr_DM_Query service by providing the 5GMSG with GUAMI(s) that are associated with the recipient ID in a Nudr_DM_Query_resp (step 315). In some cases, multiple GUAMI's may be provided to the 5GMSG service for a single UE in the case where the UE's location is not exactly known and the message should be sent to all AMF's that might be serving the recipient UE. A complete GUAMI may not need to be provided. Alternatively, UDM/UDR 304 may only need to provide part of the GUAMI (e.g. AMF Set ID and AMF Pointer) if the sender AMF and receiver AMF are part of the same AMF region. Referring to step 310, UE 301 may provide an AMF Set ID when sending a message to a recipient so that the message is sent to all AMFs in the set and the message is only to be delivered by the AMF that is serving the recipient UE.

The purpose of steps 316 and 317 includes querying the AMF that is serving the recipient(s) to obtain the 5G-GUTI of the recipient(s) so that the 5G-GUTI(s) may be provided to the UE and used as the recipient ID in subsequent requests.

5GMSG service 303 may invoke an Namf_DI_Query service by sending an Namf_DI_Query_Reqq to AMF-2 305 to obtain device information about the recipient (step 316). This service may be invoked with each AMF that was identified in step 315. When the 5GMSG service invokes the service, it provides AMF-2 305 with Recipient ID that was received in step 311.

AMF-2 305 may respond to the invocation of the Namf_DI_Query service by sending a Namf_DI_Query_Resp comprising the 5G-TMSI(s) that are associated with the Recipient ID (step 317). AMF-2 305 may respond with 5G-GUTI(s) but that is not necessary because the 5GMSG knows the identity of the AMF with which it is communicating and, by extension, the information to infer the 5G-GUTI once the 5G-TMSI is known.

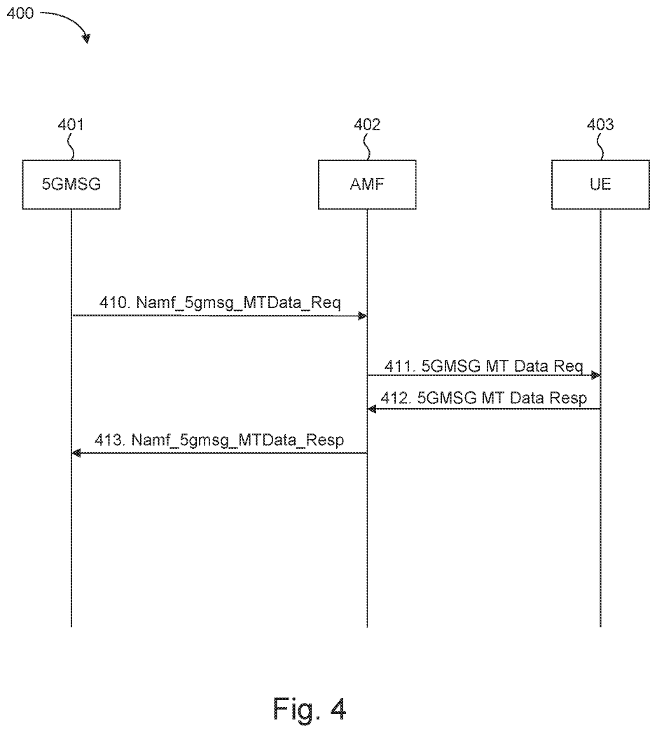

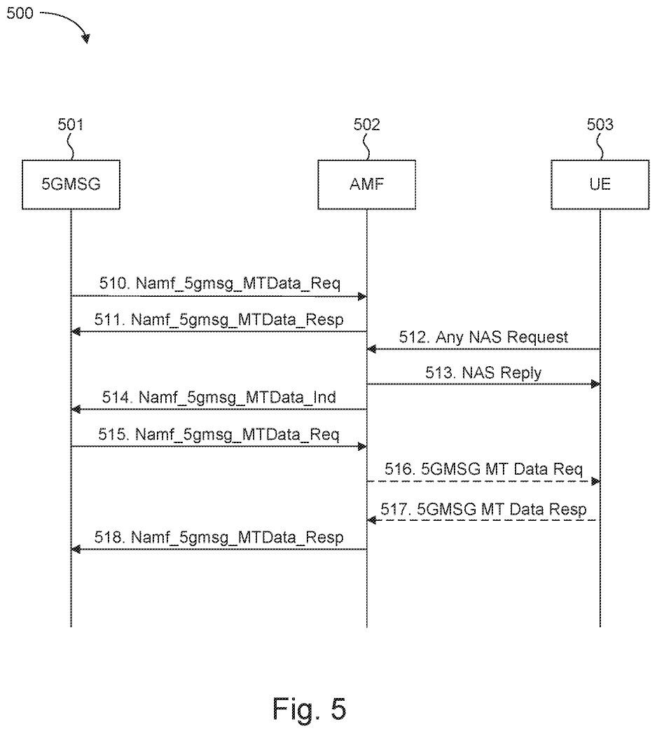

The 5GMSG service 303 may send the payload to the recipient(s) as described below in accordance with the mobile terminated data (push) procedure or mobile terminated data (pull) procedure (step 318). Note that steps 316 and 317 may be integrated with steps 410 and 413 of the procedure of FIG. 4 described below or steps 510 and 511 of the procedure of FIG. 5 described below.

Depending on the indicated Acknowledgment Preference, the 5GMSG service 303 may respond to UE 301 with a NAS-5GMSG message that includes an indication of whether or not the message was accepted for delivery by sending a N5gmsg_MOData_Resp to AMF-1 302 (step 319). This message may also indicate whether the recipient(s)' AMFs were found and whether the message was delivered to the recipient(s). The message may also comprise the recipient's 5G-GUTI (or parts of the recipient's 5G-GUTI). By providing UE 301 with the recipient's 5G-GUTI, UE 301 may identify the recipient with a 5G-GUTI when sending subsequent data to the recipient. By identifying the UE with a 5G-GUTI, 5GMSG service 303 may be able to quickly determine to which AMF to send the data (e.g., steps 314-317 may be skipped).

AMF-1 302 may then forward the NAS-5GMSG message (e.g., 5GMSG MO Data Resp) to UE 301 (step 320).

As an alternative to step 311, AMF-1 302 may use the services of the 5GMSG service 303 to request the identity of the AMF serving the intended recipient, by issuing a N5gmsg_MOData_Req. 5GMSG may proceed with steps 314-317, and then may send a N5gmsg_MOData_Resp to AMF-1 302, with the discovered identity (for example, the GUAMI of AMF-2 305). AMF-1 302 may then forward the NAS-5GMSG message received in step 310, directly to AMF-2 305, using an Namf_5gmsg_MTData_Req/Namf_5gmsg_MTData_Resp exchange.

FIG. 4 is a diagram of an example procedure 400 for use by the 5GMSG in a session less communication model to send data to a UE or a group of UEs, which may be used in any of the embodiments described herein. The procedure of FIG. 4 is an example of mobile terminated data (push) procedure depicting how the 5GMSG service forwards data to a single UE, a group of UEs, or an Application Function. In the example of FIG. 4, the UE is assumed to be awake and data can immediately be pushed to the recipient.

Referring to FIG. 4, the 5GMSG service 401 may send a NAS-5GMSG message (e.g., Namf_5gmsg_MTData_Req to the AMF(s) 402 that serves the UE(s) 403 that are to receive the message (step 410). When the message was received, such as using the procedure 300 of FIG. 3, the 5GMSG service 401 may have determined what AMF(s) 402 are serving the UE(s) 403. This determination may have been made based on a lookup with the UDM or based on the Recipient ID (e.g., if the recipient ID was a 5G-GUTI). The NAS-5GMSG may include information elements including but not limited to the following:

Message Payload: the message payload may comprise the data that is to be provided to the UE application.

Message Payload Type: the Message Payload Type may comprise an indication of the message type. The message may be a data, an acknowledgement, an acknowledgment and data, or a ping message. The purpose of a ping message may be to ensure that the UE has the recipient UE's current 5G-GUTI and that the recipient UE is reachable.

5GMSG Service ID: the 5GMSG Service ID may comprise an identity of a 5GMSG Service that is sending the message to the UE.

Recipient ID: the Recipient ID may be as described in the procedure of FIG. 3.

Recipient Application ID: the Recipient Application ID may be as described in the procedure of FIG. 3.

Sender ID: the Sender ID may be as described in the procedure of FIG. 3.

Sender Application ID: the Sender Application ID may be as described in the procedure of FIG. 3.

Acknowledgment Preference: the Acknowledgment Preference may comprise a field that indicates whether an acknowledgement is to be sent to the 5GMSG.

AMF 402 may check that the UE(s) 403, which is the recipient of the NAS-5GMSG message sent in step 410, is attached to AMF 402. If the recipient UE(s) 403 is not attached to the AMF, steps 411 and 412 may be skipped, and AMF 402 may reply with an indication that UE(s) 403 is no longer attached to the AMF. This reply may provide the 5GMSG with a new AMF's GUAMI and/or the new 5G-GUTI of the recipient UE(s) 403. If the recipient UE(s) 403 is attached to AMF 402, AMF 402 may check that the sender is authorized to the send 5GMSG messages to the recipient UE(s) 403. AMF 402 checks this by checking that whether the subscription information of the recipient UE(s) 403 indicates that the sender is authorized to send UE(s) 403 messages. If the operation is authorized, the AMF 402 may send the message (e.g., 5GMSG MT Data Req) to the UE(s) 403 (step 411). When UE(s) 403 receives the message, it may route it to the application that is identified in the NAS-5GMSG.

UE 403 may reply to AMF 402 (e.g., with a 5GMSG MT Data Resp) to indicate that the 5GMSG message has been received (step 412). The UE Application may provide an acknowledgment and/or a payload reply to be included in the response (e.g., a 5GMSG MT Data Resp). Whether UE 403 sends a response may depend on the Acknowledgment Preference that was indicated in the message.

AMF 402 may forward the NAS-5GMSG reply (e.g., Namf_5gmsg_MTData_Resp) to 5GMSG service 401 (step 413).

FIG. 5 is a diagram of an example procedure 500 for use by the 5GMSG service in a session less communication model to send data to a UE or a group of UEs, which may be used in any of the embodiments described herein. The procedure of FIG. 5 is an example of mobile terminated data (pull) procedure. In the example of FIG. 5, the UE may be sleeping. The message may be buffered in the 5GMSG or AMF until the recipient UE contacts the AMF, at which point the message may be sent to the UE.

Referring to FIG. 5, the 5GMSG service 501 may send a NAS-5GMSG message (e.g., Namf_5gmsg_MTData_Req) to the AMF(s) 502 (step 510).

If AMF 502 cannot page UE 503, AMF 502 may respond to 5GMSG 501 with an indication that UE 503 is not reachable (step 511). The reply may further indicate whether AMF 502 buffered the message or whether 5GMSG service 501 should buffer the message. The message may further indicate a maximum amount of time that UE 503 is expected to be sleeping, when UE 503 is expected to wake up or other details about the sleep schedule of UE 503. If AMF 502 can page UE 503, AMF 503 may page UE 503 and may proceed to step 516 once UE 503 responds to the page.

UE 503 may send a NAS message to AMF 502 (e.g. a Registration Request, PDU Session Establishment Request, PDU Session Modification Request, PDU Session Termination Request, or a Service Request) (step 512).

AMF 502 may include the data in a NAS reply to the message of step 512 (step 513).

If 5GMSG service 501 buffered the data, AMF 502 may sends an indication (e.g., Namf_5gmsg_MTData_Ind) to 5GMSG service 501 indicating that the UE is reachable and that the message may now be sent (step 514).

5GMSG service 501 may reply with the data (e.g., Namf_5gmsg_MTData_Req) (step 515). This data may be the data previously sent in step 510.

If data is not included in the NAS reply of step 513, AMF 502 may send a 5GMSG MT Data Request to UE 503 (step 516) as described in step 411 of the procedure of FIG. 4.

If data is sent to UE 503 in step 516, UE 503 may reply with a 5GMSG MT Data Resp (step 517) as described in step 412 of the procedure of FIG. 4. Alternatively, if the data was sent to UE 503 in step 513, UE 503 may send a NAS message to AMF 502 acknowledging the 5GMSG message.

AMF 502 may reply (e.g., Namf_5gmsg_MTData_Resp) to 5GMSG service 501 (step 518) as described in step 413 of the procedure of FIG. 4.

In order to support the 5GMSG service, the AMF (i.e. AMF-1 in FIG. 3 described above) may need to support a 5GMSG selection function. The 5GMSG selection function may be triggered by the events listed in Table 1. 5GMSG selection may involve querying the NRF with the information including but not limited to information that is listed in Table 1.

TABLE 1
Triggers for the 5GMSG Selection Function

| Trigger | Description |
|---|---|
| Registration or | A specific indication in the trigger message or the value of a field |
| PDU Session Establishment or | such as PDU Session Type, S-NSSAI, or DDN may indicate that |
| PDU Session Modification or | 5GMSG Service(s) are required. |
| Service Request | |
| Reception of any NAS-5GMSG | If the 5GMSG Service is session less, then the AMF may select a |
| message | 5GMSG service each time it receives a NAS-5GMSG message, and |
| | the message may be forwarded to the selected 5GMSG service. |

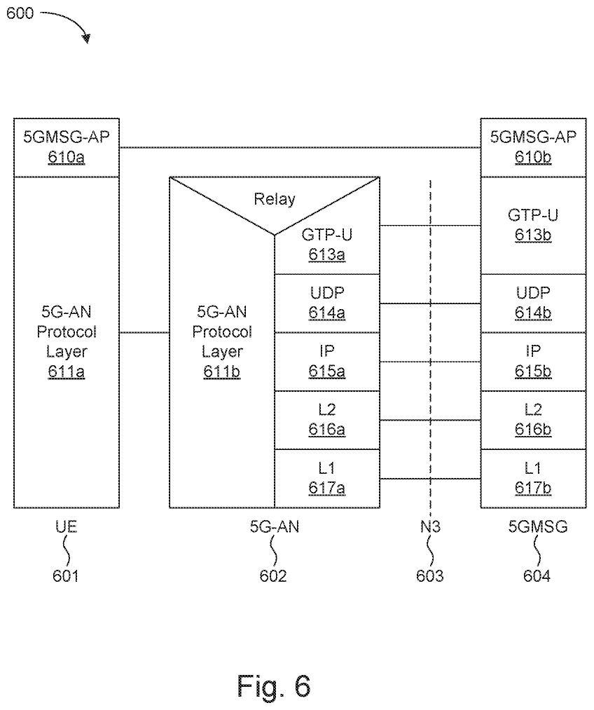

Data may be sent to and from the 5GMSG NF via the user plane (in for example a session less model) in accordance with another embodiment, which may be used in any of the embodiments described herein. FIG. 6 is a diagram of an example 5GMSG protocol stack 600 (user plane), which depicts how the 5GMSG service may communicate with UEs in the 5G system. In this example protocol stack 600, communication between UE 601 and 5GMSG service 603 may be carried on the user plane in a 5GMSG-AP protocol 610a, 610b between UE 601 and 5GMSG service 603. UE 601 may communicate with a relay operating as 5G-AN 602 via the 5G-AN protocol layer 611a, 611b. The relay operating as 5G-AN 602 and 5GMSG service 603 may communicate over the N3 interface 604 via GTP-U protocol 613, 613; UDP protocol 614a, 614b; IP 615a, 615b; L2 protocol 616a, 616b; and L1 protocol 617a, 617b.

The 5GMSG functionality may be part of another NF, such as a UPF, RAN node, AMF or SMF. The 5GMSG-AP functionality may be part of the PDU layer protocol. In an alternative embodiment, the interface between the 5G-AN 602 and 5GMSG service 603 may use other protocols such as RESTful protocols including but not limited to HTTP.

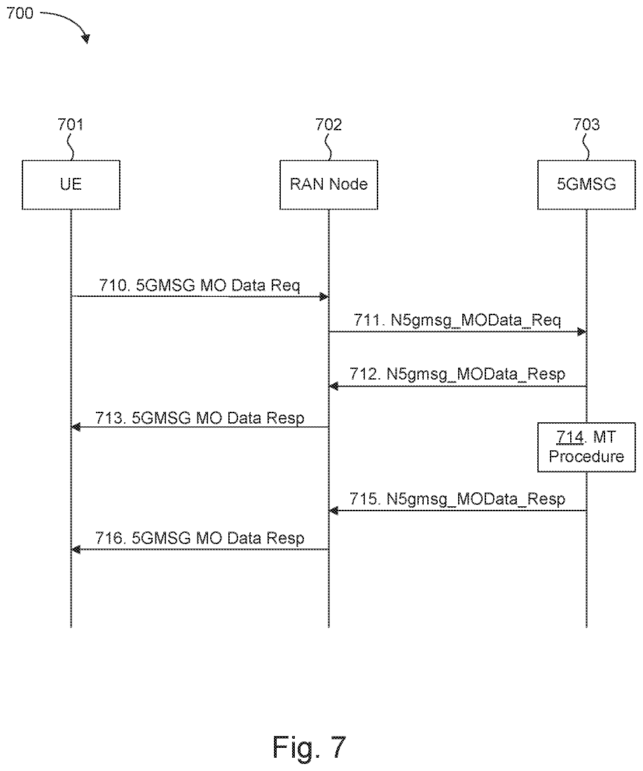

FIG. 7 is a diagram of an example procedure 700 for use by a UE in a session less communication model to send data to the 5GMSG service via a user plane connection, which may be used in any of the embodiments described herein. The procedure of FIG. 7 is an example of mobile originated data procedure. The data may be addressed to a single UE, a group of UEs, or an Application Function.

In the example of FIG. 7, an application on UE 701 may invoke an API to cause UE 701 to send data to the 5GMSG Service 703 by, for example, sending a 5GMSG MO Data Req message (step 710). The data may be addressed to application(s) that are hosted on other UE(s) or an Application Function. The data may be part of a 5GMSG-AP message. The 5GMSG-AP message may include the information elements including but not limited to the following:

Message Payload: the message payload may comprise data that was provided when the UE application invoked the API.

Message Payload Type: the Message Payload Type may comprise an indication of the message type. The message may comprise data, an acknowledgement, an acknowledgment and data, or a ping message. The purpose of a ping message may be to ensure that the UE has the recipient UE's current 5G-GUTI and that the recipient UE is reachable.

5GMSG Service ID: the 5GMSG Service ID may comprise an identity of a 5GMSG Service or an identity that the network may use to resolve the 5GMSG Service NF. The value may be provided by the UE application when it invokes the API or it may be provisioned in the UE (e.g. in the SIM card and/or via OMA DM procedures).

Recipient ID: the Recipient ID may comprise an Application Function ID. The Recipient ID may comprise a UE ID. The UE ID may comprise an External Identifier. The Recipient ID may comprise a Group ID. The Group ID may comprise an External Group Identifier.

Recipient ID Assistance Info: the Recipient ID Assistance Info may comprise the Recipient's expected GUAMI, or only parts of the GUAMI such as the AMF Region ID, AMF Set ID, or AMF Pointer.

Recipient Application ID: the recipient application ID may comprise an identifier that may be used by the recipient UE(s) to route the message payload to the appropriate Application on the UE or used by the recipient AF to route the message payload to the appropriate Application, SCS/AS, or AS.

Sender ID: the Sender ID may comprise a UE ID. The UE ID may comprise an External Identifier. The Sender ID may comprise a specific identifier that is associated with the UE's use of the 5GMSG Service.

Sender Application ID: the Sender Application ID may comprise an identifier that is used to identify the application on the sending UE that initiated the message. The recipient application may use this identifier when sending messages (i.e. replies) to the sending application.

Acknowledgment Preference: the Acknowledgment Preference field may indicate whether the sender wants an acknowledgement and whether the acknowledgement is to be sent when the message reaches the 5GMSG, when 5GMSG locates the recipient, when the 5GMSG sends the message to the recipient's serving AMF, or when the 5GMSG receives an acknowledgment from the recipient.

Referring to FIG. 7, RAN Node 702 may use the 5GMSG Service ID to determine what 5GMSG NF to which to send the message and send the message (e.g., N5gmsg_MOData_Req) to the determined 5GMSG service 703 (step 711). If no 5GMSG Service ID is provided, RAN Node 702 may resolve, or determine, a 5GMSG Service ID based on the identity of the UE, the indicated Sender ID, Receiver ID, UE location, and/or location of the receiver.

Depending on the indicated Acknowledgment Preference, 5GMSG service 703 may respond to UE 701 with a 5GMSG-AP message that includes an indication of whether or not the message was accepted for delivery by sending an N5gmsg_MOData_Resp to RAN Node 702 (step 712).

RAN Node 702 may forward the 5GMSG-AP reply message that was received in step 712 to UE 701 (step 713).

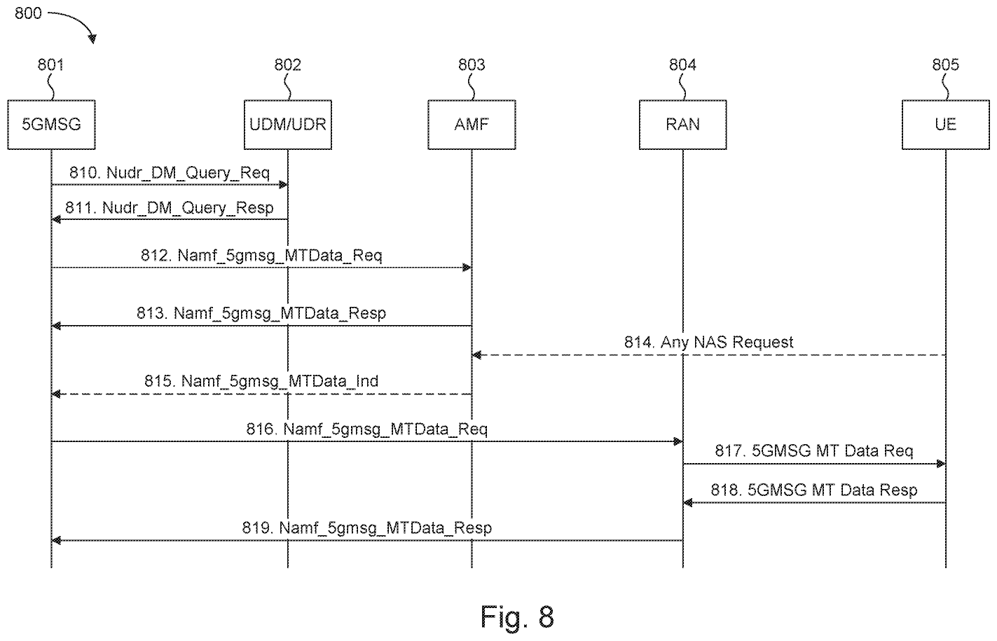

5GMSG service 703 may use the mobile terminated data (push and pull) procedure described below with respect to FIG. 8 in order to send that message to the recipient (step 714).

Depending on the indicated Acknowledgment Preference, 5GMSG service 703 may respond to UE 701 with a 5GMSG-AP message (e.g., N5gmsg_MOData_Resp) that includes an indication of whether or not the message was accepted for delivery (step 715). This message may also indicate if the recipient(s)' RAN Nodes were found and if the message was delivered to the recipient(s).

RAN Node may forward the 5GMSG-AP message (e.g., 5GMSG MO Data Resp) to UE 701 (step 716).

FIG. 8 is a diagram of an example procedure 800 for use by a UE in a session less communication model to send data to the 5GMSG service via a user plane connection, which may be used in any of the embodiments described herein. The procedure of FIG. 8 is an example of a mobile terminated data (push and pull) procedure and depicts how a 5GMSG service may forward data to a single UE, group of UEs, or Application Function. FIG. 8 depicts a procedure that may be used by the 5GMSG service in a session less user plane communication model in order to send data to a UE or a group of UEs.

In the example of FIG. 8, when the UE is awake and ready to receive data, steps 814 and 815 may be skipped. When the UE is not available to receive data the AMF may indicate to the 5GMSG service that the UE is not reachable (in step 813) and may send an indication to the 5GMSG when the UE becomes reachable (in step 815).

Once the 5GMSG service knows the RAN node that is serving the UE, steps 810-815 may be skipped, and the 5GMSG service may send messages directly to the RAN node. The 5GMSG NF may subscribe to the RAN node or AMF for a notification of any change to which RAN node is serving the UE so that the 5GMSG may quickly establish a connection to the new RAN node.

Referring to FIG. 8, after receiving a message to send to a recipient UE, the 5GMSG service 801 may send a Nudr_DM_Query_Req message to UDM/UDR 802 to invoke the Nudr_DM_Query_Req service to determine which AMF is serving the recipient UE(s) (step 810).

The UDM/UDR 802 may check that the UE(s) is authorized to use the 5GMSG service and is authorized to send a 5GMSG message to the recipient. If the authorization is successful, the UDM/UDR 802 may reply to the invocation of the Nudr_DM_Query_Req service by sending a Nudr_DM_Query_Resp to 5GMSG service 801 and may provide the 5GMSG NF with the identity of the AMF that is serving the recipient UE (step 811).

The 5GMSG service may invoke the N5gmsg_MTData service by sending a Namf_5gmsg_MTData_Req to 5GMSG service 801 in order to determine which RAN node is serving the UE and to determine if the UE is reachable (step 812).

AMF 803 may check that the UE(s) is authorized to use 5GMSG service 801 and is authorized to send a 5GMSG message to the recipient UE(s). If the UE(s) is reachable, AMF 803 may provide 5GMSG service 801 with the RAN Node identity by sending a Namf_5gmsg_MTData_Resp to 5GMSG service 801 (step 813) and steps 5 and 6 may be skipped. Otherwise, AMF 803 may respond with an indication that the UE is not reachable, and AMF 803 may create a subscription for 5GMSG service 801 so that a notification may also be sent to 5GMSG service 801 when UE 805 becomes reachable. AMF 803 may initiate paging of UE 805 at this time (not shown). The page may indicate that the purpose of the page is for a low latency message.

UE 805 may send a NAS message to AMF 803 (e.g., a registration message or a service request message) and thus it becomes reachable (step 814). This message may also be a message that explicitly indicates that the purpose of the requests to request messages from the 5GMSG service. For example, the message may indicate the identity of the 5GMSG service from which the UE wants to receive messages.

AMF 803 may send a notification (e.g., Namf_5gmsg_MTData_Ind) to 5GMSG service 801 that the UE is now reachable. The indication may include the identity of the RAN node that is serving the UE.

The 5GMSG service 801 may send the message (e.g., Namf_5gmsg_MTData_Req) to the identified RAN node (e.g., RAN node 804) (step 816).

RAN Node 804 may send the message (e.g., 5GMSG MT Data Req) to the UE 805 (step 817).

UE 805 may send an acknowledgement message (e.g., 5GMSG MT Data Resp) to RAN node 804 (step 818).

RAN node 804 may forward the acknowledgement (e.g., Namf_5gmsg_MTData_Resp) to 5GMSG service 801 (step 819).

The 5GMSG service may be implemented in the control plane (session based model) in accordance with another embodiment, which may be used in combination with any of the embodiments described herein. The example of FIG. 2 depicts how the 5GMSG service may communicate with UEs in the 5G system over the control plane. If the 5GMSG service is implemented as a part of the SMF in FIG. 2, the NAS-5GMSG protocol may be replaced by the NAS-SM protocol and the functionality required by NAS-5GMSG may be added to the NAS-SM protocol.

A PDU Session may then be established between the UE and the 5GMSG/SMF. The UE may use the PDU Session Establishment procedure (described with respect to FIG. 1) to establish the low latency messaging (5GMSG) PDU session. The PDU session establishment request (step 110 of the procedure 100 of FIG. 1) may include an indication that the session type is low latency messaging (i.e. 5GMSG functionality). Thus, this PDU session may be different from what is described with respect to FIG. 1, where the PDU session may terminate at a UPF. While this session is a CP session, no UPF would need to be associated with the session. The establishment request may further indicate a session end-point, where the session may end at another UE, or group of UEs, instead of the 5GMSG/SMF NF. When the session request indicates that session messages terminate at a particular UE, or group of UEs, the establishment procedure may include a step where the 5GMSG/SMF NF checks that the sending UE is authorized to send low latency messages to the recipient UE, or group of recipient UEs. For example, this check may happen as a part of step 113 of the procedure 100 of FIG. 1.

The 5GMSG service may be implemented in the user plane (Session Based Model) in accordance with another embodiment, which may be used in combination with any of the embodiments described herein. FIG. 6 depicts how the 5GMSG service may communicate with UEs in the 5G system via the user plane. If the 5GMSG service is to be part of the UPF in FIG. 6, the 5GMSG-AP protocol may be replaced by the PDU Layer, and the functionality required by 5GMSG-AP may be added to the PDU Layer protocol. In order to decrease messaging latency, the UPF/5GMSG functionality may be integrated with the RAN node.

When a session is established between the UE and 5GMSG in a user plane embodiment, the session establishment may still occur between the UE and the SMF. The UE may use the PDU Session Establishment procedure (described with respect to FIG. 1) to establish the low latency messaging (5GMSG) PDU session. The PDU session establishment request (step 110 of the procedure 100 of FIG. 1) may include an indication that the session type is low latency messaging (i.e. 5GMSG functionality). When this indication is provided during PDU session establishment, the SMF may select a 5GMSG service instance instead of selecting a UPF, or select a UPF with embedded 5GMSG functionality. If the 5GMSG functionality is part of the RAN node, then the SMF may not need to select an anchor for the session, the RAN node may be the anchor. The SMF may know that the RAN node supports 5GMSG functionality based on an indication that is added to the Nsmf_PDUSession_CreateSMContext Request by the AMF or an indication that is added to the PDU Session Establishment Request that is added by the UE.

For the case of a Session Based Control Plane mode, the establishment request may further indicate a session end-point, where the session may end at another UE, or group of UEs, instead of the 5GMSG/UPF NF. When the session request indicates that session messages terminate at a particular UE, or group of UEs, the establishment procedure may include a step where the 5GMSG/SMF NF checks that the UE is authorized to send low latency messages to the UE, or group of UE. For example, this check may happen as a part of step 113 of the procedure 100 of FIG. 1.

The 5GMSG service may provide support for 3rd Party Application Servers in accordance with another embodiment, which may be used in combination with any of the embodiments described herein. The procedures in the earlier sections describe how a UE may send data to the 5GMSG and receive data from the 5GMSG service. The procedures may be modified to support the case where an Application Server (e.g. AF, SCS/AS, and/or IoT Server) sends data to the 5GMSG service and receives data from the 5GMSG. The Application Server may communicate with the 5GMSG service via a set of APIs. Communications may be routed via the NEF. The API may allow the Application Server to send data to UEs via the 5GMSG and receive data from UEs via the 5GMSG.

The 5GMSG service may provide support for group messaging in accordance with another embodiment, which may be used in combination with any of the embodiments described herein. FIG. 3 and FIG. 7 depict procedures for MO messaging. Step 310 and 710 of these procedures may allow the UE to send messages to groups of devices. The groups may be identified with an External Group ID. When the group is identified with an External Group ID, the 5GMSG may use the UDM/UDR to resolve the External Group ID to a set of UE Identifiers (e.g. 5G-GUTI). The 5GMSG may then use the UE Identifier to send the data to each UE.

Alternatively, step 310 of FIG. 3 and step 710 of FIG. 7 may allow the UE to send a message to all UEs in a given geographical area. The geographical area may be a Cell ID, set of Cell IDs, GPS coordinates with a radius, an AMF ID (GUAMI), an AMF Set ID, an AMF Region ID, or an indication that the message is to be sent to all devices that are served by the AMF to which the UE is currently attached. Step 310 of FIG. 3 and step 710 of FIG. 7 may further indicate that the message is to be sent to certain devices type, devices that belong to a certain group, or devices that are associated with the sending UE. The 5GMSG may then forward the message to each AMF that is associated with the indicated geographical area.

When the AMF may unicast the message to each UE in the group or send a broadcast message. A broadcast message from the AMF may be a single message that is sent from the AMF to the RAN that the RAN transmits so that multiple UEs may receive the same message. The message may be a NAS broadcast message that is sent on an N1 connection that is shared among multiple UEs.

The last steps of FIG. 3 and FIG. 7 may provide the UE with a GUAMI (or parts of a GUAMI such as AMF Set ID) that map to the group ID or geographical region that was provided in step 310 of FIG. 3 or step 710 of FIG. 7. The UE may then use this identifier in subsequent MO data request to indicate where the data should be sent.

FIG. 3 and FIG. 7 depict how the UE may send messages to another UE by addressing the recipient with a 5G-GUTI. A UE's 5G-GUTI may change if it moves to another AMF. Thus, when the UE sends a message to the network, it may indicate if it wants to subscribe to changes in the recipient's 5G-GUTI. The 5GMSG may then subscribe to the recipient's AMF to be notified of changes to recipient's 5G-GUTI. When the recipient UE moves to a new AMF, the new AMF may send a notification to the 5GMSG of the recipient UE's new 5G-GUTI. The 5GMSG may then send a notification to the sender UE indicating the recipient's 5G-GUTI has changed. The indicate message may include the new and the old 5G-GUTI. The message may be part of a NAS message such as a configuration update or NAS notification.

From a security standpoint it may not be desirable to expose a UE's 5G-GUTI to other UE's or NF's other than the UE's serving AMF. Thus, when the AMF provides a UE identifier, such as the UE's 5G-GUTI, to another NF so that it may eventually be provided to another UE, the AMF may hash, or encrypt, the UE's 5G-GUTI. For example, the AMF may hash the 5G-GUTI with the identity of the requesting AMF and/or UE so that the requesting AMF and UE would not know the UE's true 5G-GUTI. When the hashed identity is used to identify a message recipient, the AMF may use the identity of the requesting AMF and/or UE to retrieve the original 5G-GUTI.

When a UE sends MO data, it may hash its own 5G-GUTI and use it to identity itself as the sender. The inputs to the hash function may be the 5G-GUTI, the UE's IMSI, the UE's external identifier, and the message recipient. In this case, it may be preferable to hash the 5G-TMSI portion of the 5G-GUTI so that the message recipient and the message recipient's AMF may be able to identify which AMF is serving the UE.

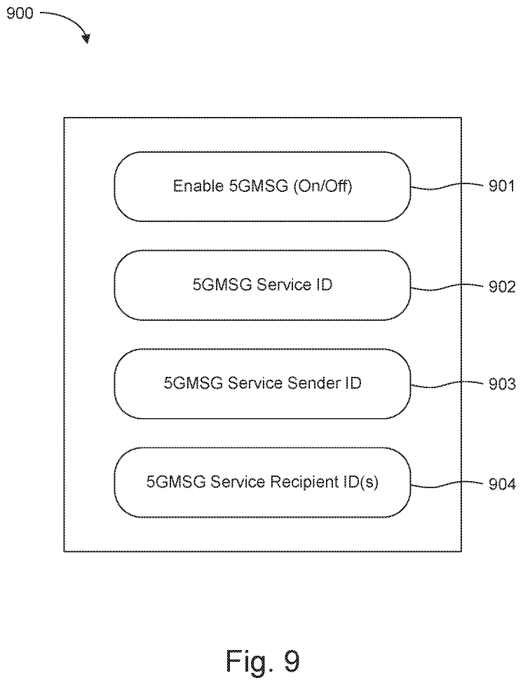

FIG. 9 is a diagram of an example graphical user interface (GUI) 900 that a UE may display for configuring the 5GMSG service in accordance with another embodiment, which may be used in any of the embodiments described herein. The “Enable 5GMSG (On/Off)” 901 button may be used to enable and disable the feature. The “5GMSG Service ID” 902 button may be used to identify the instance of the service that is to be used to send and receive data. The “5GMSG Service Sender ID” 903 button may be pressed and a new window may open to allow the user to enter a Sender ID to be used in step 310 of FIG. 3 and step 710 of FIG. 7. The “5GMSG Service Recipient ID(s)” 904 button may be pressed and new window may open to allow the user to enter Recipient ID(s) that are to be used in step 310 of FIG. 3 and step 710 of FIG. 7. Entering Recipient ID(s) may trigger the UE to send ping messages to the recipients in order to obtain and track the recipient's 5G-GUTI.

The 3rd Generation Partnership Project (3GPP) develops technical standards for cellular telecommunications network technologies, including radio access, the core transport network, and service capabilities—including work on codecs, security, and quality of service. Recent radio access technology (RAT) standards include WCDMA (commonly referred as 3G), LTE (commonly referred as 4G), LTE-Advanced standards, and New Radio (NR), which is also referred to as “5G”. 3GPP NR standards development is expected to continue and include the definition of next generation radio access technology (new RAT), which is expected to include the provision of new flexible radio access below 7 GHz, and the provision of new ultra-mobile broadband radio access above 7 GHz. The flexible radio access is expected to consist of a new, non-backwards compatible radio access in new spectrum below 7 GHz, and it is expected to include different operating modes that may be multiplexed together in the same spectrum to address a broad set of 3GPP NR use cases with diverging requirements. The ultra-mobile broadband is expected to include cmWave and mmWave spectrum that will provide the opportunity for ultra-mobile broadband access for, e.g., indoor applications and hotspots. In particular, the ultra-mobile broadband is expected to share a common design framework with the flexible radio access below 7 GHz, with cmWave and mmWave specific design optimizations.

3GPP has identified a variety of use cases that NR is expected to support, resulting in a wide variety of user experience requirements for data rate, latency, and mobility. The use cases include the following general categories: enhanced mobile broadband (eMBB) ultra-reliable low-latency Communication (URLLC), massive machine type communications (mMTC), network operation (e.g., network slicing, routing, migration and interworking, energy savings), and enhanced vehicle-to-everything (eV2X) communications, which may include any of Vehicle-to-Vehicle Communication (V2V), Vehicle-to-Infrastructure Communication (V2I), Vehicle-to-Network Communication (V2N), Vehicle-to-Pedestrian Communication (V2P), and vehicle communications with other entities. Specific service and applications in these categories include, e.g., monitoring and sensor networks, device remote controlling, bi-directional remote controlling, personal cloud computing, video streaming, wireless cloud-based office, first responder connectivity, automotive ecall, disaster alerts, real-time gaming, multi-person video calls, autonomous driving, augmented reality, tactile internet, virtual reality, home automation, robotics, and aerial drones to name a few. All of these use cases and others are contemplated herein.

FIG. 10A illustrates an example communications system 100 in which the systems, methods, and apparatuses described and claimed herein may be used. The communications system 100 may include wireless transmit/receive units (WTRUs) 102a, 102b, 102c, 102d, 102e, 102f, and/or 102g, which generally or collectively may be referred to as WTRU 102 or WTRUs 102. The communications system 100 may include, a radio access network (RAN) 103/104/105/103b/104b/105b, a core network 106/107/109, a public switched telephone network (PSTN) 108, the Internet 110, other networks 112, and Network Services 113. 113. Network Services 113 may include, for example, a V2X server, V2X functions, a ProSe server, ProSe functions, IoT services, video streaming, and/or edge computing, etc.

It will be appreciated that the concepts disclosed herein may be used with any number of WTRUs, base stations, networks, and/or network elements. Each of the WTRUs 102 may be any type of apparatus or device configured to operate and/or communicate in a wireless environment. In the example of FIG. 10A, each of the WTRUs 102 is depicted in FIGS. 10A-10E as a hand-held wireless communications apparatus. It is understood that with the wide variety of use cases contemplated for wireless communications, each WTRU may comprise or be included in any type of apparatus or device configured to transmit and/or receive wireless signals, including, by way of example only, user equipment (UE), a mobile station, a fixed or mobile subscriber unit, a pager, a cellular telephone, a personal digital assistant (PDA), a smartphone, a laptop, a tablet, a netbook, a notebook computer, a personal computer, a wireless sensor, consumer electronics, a wearable device such as a smart watch or smart clothing, a medical or eHealth device, a robot, industrial equipment, a drone, a vehicle such as a car, bus or truck, a train, or an airplane, and the like.

The communications system 100 may also include a base station 114a and a base station 114b. In the example of FIG. 10A, each base stations 114a and 114b is depicted as a single element. In practice, the base stations 114a and 114b may include any number of interconnected base stations and/or network elements. Base stations 114a may be any type of device configured to wirelessly interface with at least one of the WTRUs 102a, 102b, and 102c to facilitate access to one or more communication networks, such as the core network 106/107/109, the Internet 110, Network Services 113, and/or the other networks 112. Similarly, base station 114b may be any type of device configured to wiredly and/or wirelessly interface with at least one of the Remote Radio Heads (RRHs) 118a, 118b, Transmission and Reception Points (TRPs) 119a, 119b, and/or Roadside Units (RSUs) 120a and 120b to facilitate access to one or more communication networks, such as the core network 106/107/109, the Internet 110, other networks 112, and/or Network Services 113. RRHs 118a, 118b may be any type of device configured to wirelessly interface with at least one of the WTRUs 102, e.g., WTRU 102c, to facilitate access to one or more communication networks, such as the core network 106/107/109, the Internet 110, Network Services 113, and/or other networks 112.

TRPs 119a, 119b may be any type of device configured to wirelessly interface with at least one of the WTRU 102d, to facilitate access to one or more communication networks, such as the core network 106/107/109, the Internet 110, Network Services 113, and/or other networks 112. RSUs 120a and 120b may be any type of device configured to wirelessly interface with at least one of the WTRU 102e or 102f, to facilitate access to one or more communication networks, such as the core network 106/107/109, the Internet 110, other networks 112, and/or Network Services 113. By way of example, the base stations 114a, 114b may be a Base Transceiver Station (BTS), a Node-B, an eNode B, a Home Node B, a Home eNode B, a Next Generation Node-B (gNode B), a satellite, a site controller, an access point (AP), a wireless router, and the like.

The base station 114a may be part of the RAN 103/104/105, which may also include other base stations and/or network elements (not shown), such as a Base Station Controller (BSC), a Radio Network Controller (RNC), relay nodes, etc. Similarly, the base station 114b may be part of the RAN 103b/104b/105b, which may also include other base stations and/or network elements (not shown), such as a BSC, a RNC, relay nodes, etc. The base station 114a may be configured to transmit and/or receive wireless signals within a particular geographic region, which may be referred to as a cell (not shown). Similarly, the base station 114b may be configured to transmit and/or receive wired and/or wireless signals within a particular geographic region, which may be referred to as a cell (not shown). The cell may further be divided into cell sectors. For example, the cell associated with the base station 114a may be divided into three sectors. Thus, for example, the base station 114a may include three transceivers, e.g., one for each sector of the cell. The base station 114a may employ Multiple-Input Multiple Output (MIMO) technology and, therefore, may utilize multiple transceivers for each sector of the cell, for instance.

The base station 114a may communicate with one or more of the WTRUs 102a, 102b, 102c, and 102g over an air interface 115/116/117, which may be any suitable wireless communication link (e.g., Radio Frequency (RF), microwave, infrared (IR), ultraviolet (UV), visible light, cmWave, mmWave, etc.). The air interface 115/116/117 may be established using any suitable Radio Access Technology (RAT).

The base station 114b may communicate with one or more of the RRHs 118a and 118b, TRPs 119a and 119b, and/or RSUs 120a and 120b, over a wired or air interface 115b/116b/117b, which may be any suitable wired (e.g., cable, optical fiber, etc.) or wireless communication link (e.g., RF, microwave, IR, UV, visible light, cmWave, mmWave, etc.). The air interface 115b/116b/117b may be established using any suitable RAT.

The RRHs 118a, 118b, TRPs 119a, 119b and/or RSUs 120a, 120b, may communicate with one or more of the WTRUs 102c, 102d, 102e, 102f over an air interface 115c/116c/117c, which may be any suitable wireless communication link (e.g., RF, microwave, IR, ultraviolet UV, visible light, cmWave, mmWave, etc.) The air interface 115c/116c/117c may be established using any suitable RAT.

The WTRUs 102 may communicate with one another over a direct air interface 115d/116d/117d, such as Sidelink communication which may be any suitable wireless communication link (e.g., RF, microwave, IR, ultraviolet UV, visible light, cmWave, mmWave, etc.) The air interface 115d/116d/117d may be established using any suitable RAT.

The communications system 100 may be a multiple access system and may employ one or more channel access schemes, such as CDMA, TDMA, FDMA, OFDMA, SC-FDMA, and the like. For example, the base station 114a in the RAN 103/104/105 and the WTRUs 102a, 102b, 102c, or RRHs 118a, 118b,TRPs 119a, 119b and/or RSUs 120a and 120b in the RAN 103b/104b/105b and the WTRUs 102c, 102d, 102e, and 102f, may implement a radio technology such as Universal Mobile Telecommunications System (UMTS) Terrestrial Radio Access (UTRA), which may establish the air interface 115/116/117 and/or 115c/116c/117c respectively using Wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

The base station 114a in the RAN 103/104/105 and the WTRUs 102a, 102b, 102c, and 102g, or RRHs 118a and 118b, TRPs 119a and 119b, and/or RSUs 120a and 120b in the RAN 103b/104b/105b and the WTRUs 102c, 102d, may implement a radio technology such as Evolved UMTS Terrestrial Radio Access (E-UTRA), which may establish the air interface 115/116/117 or 115c/116c/117c respectively using Long Term Evolution (LTE) and/or LTE-Advanced (LTE-A), for example. The air interface 115/116/117 or 115c/116c/117c may implement 3GPP NR technology. The LTE and LTE-A technology may include LTE D2D and/or V2X technologies and interfaces (such as Sidelink communications, etc.) Similarly, the 3GPP NR technology may include NR V2X technologies and interfaces (such as Sidelink communications, etc.)

The base station 114a in the RAN 103/104/105 and the WTRUs 102a, 102b, 102c, and 102g or RRHs 118a and 118b, TRPs 119a and 119b, and/or RSUs 120a and 120b in the RAN 103b/104b/105b and the WTRUs 102c, 102d, 102e, and 102f may implement radio technologies such as IEEE 802.16 (e.g., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114c in FIG. 10A may be a wireless router, Home Node B, Home eNode B, or access point, for example, and may utilize any suitable RAT for facilitating wireless connectivity in a localized area, such as a place of business, a home, a vehicle, a train, an aerial, a satellite, a manufactory, a campus, and the like. The base station 114c and the WTRUs 102, e.g., WTRU 102e, may implement a radio technology such as IEEE 802.11 to establish a Wireless Local Area Network (WLAN). Similarly, the base station 114c and the WTRUs 102, e.g., WTRU 102d, may implement a radio technology such as IEEE 802.15 to establish a wireless personal area network (WPAN). The base station 114c and the WTRUs 102, e.g., WRTU 102e, may utilize a cellular-based RAT (e.g., WCDMA, CDMA2000, GSM, LTE, LTE-A, NR, etc.) to establish a picocell or femtocell. As shown in FIG. 10A, the base station 114c may have a direct connection to the Internet 110. Thus, the base station 114c may not be required to access the Internet 110 via the core network 106/107/109.

The RAN 103/104/105 and/or RAN 103b/104b/105b may be in communication with the core network 106/107/109, which may be any type of network configured to provide voice, data, messaging, authorization and authentication, applications, and/or Voice Over Internet Protocol (VoIP) services to one or more of the WTRUs 102. For example, the core network 106/107/109 may provide call control, billing services, mobile location-based services, pre-paid calling, Internet connectivity, packet data network connectivity, Ethernet connectivity, video distribution, etc., and/or perform high-level security functions, such as user authentication.

Although not shown in FIG. 10A, it will be appreciated that the RAN 103/104/105 and/or RAN 103b/104b/105b and/or the core network 106/107/109 may be in direct or indirect communication with other RANs that employ the same RAT as the RAN 103/104/105 and/or RAN 103b/104b/105b or a different RAT. For example, in addition to being connected to the RAN 103/104/105 and/or RAN 103b/104b/105b, which may be utilizing an E-UTRA radio technology, the core network 106/107/109 may also be in communication with another RAN (not shown) employing a GSM or NR radio technology.

The core network 106/107/109 may also serve as a gateway for the WTRUs 102 to access the PSTN 108, the Internet 110, and/or other networks 112. The PSTN 108 may include circuit-switched telephone networks that provide Plain Old Telephone Service (POTS). The Internet 110 may include a global system of interconnected computer networks and devices that use common communication protocols, such as the Transmission Control Protocol (TCP), User Datagram Protocol (UDP), and the internet protocol (IP) in the TCP/IP internet protocol suite. The other networks 112 may include wired or wireless communications networks owned and/or operated by other service providers. For example, the networks 112 may include any type of packet data network (e.g., an IEEE 802.3 Ethernet network) or another core network connected to one or more RANs, which may employ the same RAT as the RAN 103/104/105 and/or RAN 103b/104b/105b or a different RAT.

Some or all of the WTRUs 102a, 102b, 102c, 102d, 102e, and 102f in the communications system 100 may include multi-mode capabilities, e.g., the WTRUs 102a, 102b, 102c, 102d, 102e, and 102f may include multiple transceivers for communicating with different wireless networks over different wireless links. For example, the WTRU 102g shown in FIG. 10A may be configured to communicate with the base station 114a, which may employ a cellular-based radio technology, and with the base station 114c, which may employ an IEEE 802 radio technology.

Although not shown in FIG. 10A, it will be appreciated that a User Equipment may make a wired connection to a gateway. The gateway maybe a Residential Gateway (RG). The RG may provide connectivity to a Core Network 106/107/109. It will be appreciated that many of the ideas contained herein may equally apply to UEs that are WTRUs and UEs that use a wired connection to connect to a network. For example, the ideas that apply to the wireless interfaces 115, 116, 117 and 115c/116c/117c may equally apply to a wired connection.

FIG. 10B is a system diagram of an example RAN 103 and core network 106. As noted above, the RAN 103 may employ a UTRA radio technology to communicate with the WTRUs 102a, 102b, and 102c over the air interface 115. The RAN 103 may also be in communication with the core network 106. As shown in FIG. 10B, the RAN 103 may include Node-Bs 140a, 140b, and 140c, which may each include one or more transceivers for communicating with the WTRUs 102a, 102b, and 102c over the air interface 115. The Node-Bs 140a, 140b, and 140c may each be associated with a particular cell (not shown) within the RAN 103. The RAN 103 may also include RNCs 142a, 142b. It will be appreciated that the RAN 103 may include any number of Node-Bs and Radio Network Controllers (RNCs.)

As shown in FIG. 10B, the Node-Bs 140a, 140b may be in communication with the RNC 142a. Additionally, the Node-B 140c may be in communication with the RNC 142b. The Node-Bs 140a, 140b, and 140c may communicate with the respective RNCs 142a and 142b via an Iub interface. The RNCs 142a and 142b may be in communication with one another via an Iur interface. Each of the RNCs 142a and 142b may be configured to control the respective Node-Bs 140a, 140b, and 140c to which it is connected. In addition, each of the RNCs 142a and 142b may be configured to carry out or support other functionality, such as outer loop power control, load control, admission control, packet scheduling, handover control, macro-diversity, security functions, data encryption, and the like.

The core network 106 shown in FIG. 10B may include a media gateway (MGW) 144, a Mobile Switching Center (MSC) 146, a Serving GPRS Support Node (SGSN) 148, and/or a Gateway GPRS Support Node (GGSN) 150. While each of the foregoing elements are depicted as part of the core network 106, it will be appreciated that any one of these elements may be owned and/or operated by an entity other than the core network operator.

The RNC 142a in the RAN 103 may be connected to the MSC 146 in the core network 106 via an IuCS interface. The MSC 146 may be connected to the MGW 144. The MSC 146 and the MGW 144 may provide the WTRUs 102a, 102b, and 102c with access to circuit-switched networks, such as the PSTN 108, to facilitate communications between the WTRUs 102a, 102b, and 102c, and traditional land-line communications devices.

The RNC 142a in the RAN 103 may also be connected to the SGSN 148 in the core network 106 via an IuPS interface. The SGSN 148 may be connected to the GGSN 150. The SGSN 148 and the GGSN 150 may provide the WTRUs 102a, 102b, and 102c with access to packet-switched networks, such as the Internet 110, to facilitate communications between and the WTRUs 102a, 102b, and 102c, and IP-enabled devices.

The core network 106 may also be connected to the other networks 112, which may include other wired or wireless networks that are owned and/or operated by other service providers.

FIG. 10C is a system diagram of an example RAN 104 and core network 107. As noted above, the RAN 104 may employ an E-UTRA radio technology to communicate with the WTRUs 102a, 102b, and 102c over the air interface 116. The RAN 104 may also be in communication with the core network 107.

The RAN 104 may include eNode-Bs 160a, 160b, and 160c, though it will be appreciated that the RAN 104 may include any number of eNode-Bs. The eNode-Bs 160a, 160b, and 160c may each include one or more transceivers for communicating with the WTRUs 102a, 102b, and 102c over the air interface 116. For example, the eNode-Bs 160a, 160b, and 160c may implement MIMO technology. Thus, the eNode-B 160a, for example, may use multiple antennas to transmit wireless signals to, and receive wireless signals from, the WTRU 102a.

Each of the eNode-Bs 160a, 160b, and 160c may be associated with a particular cell (not shown) and may be configured to handle radio resource management decisions, handover decisions, scheduling of users in the uplink and/or downlink, and the like. As shown in FIG. 10C, the eNode-Bs 160a, 160b, and 160c may communicate with one another over an X2 interface.

The core network 107 shown in FIG. 10C may include a Mobility Management Gateway (MME) 162, a serving gateway 164, and a Packet Data Network (PDN) gateway 166. While each of the foregoing elements are depicted as part of the core network 107, it will be appreciated that any one of these elements may be owned and/or operated by an entity other than the core network operator.

The MME 162 may be connected to each of the eNode-Bs 160a, 160b, and 160c in the RAN 104 via an S1 interface and may serve as a control node. For example, the MME 162 may be responsible for authenticating users of the WTRUs 102a, 102b, and 102c, bearer activation/deactivation, selecting a particular serving gateway during an initial attach of the WTRUs 102a, 102b, and 102c, and the like. The MME 162 may also provide a control plane function for switching between the RAN 104 and other RANs (not shown) that employ other radio technologies, such as GSM or WCDMA.

The serving gateway 164 may be connected to each of the eNode-Bs 160a, 160b, and 160c in the RAN 104 via the S1 interface. The serving gateway 164 may generally route and forward user data packets to/from the WTRUs 102a, 102b, and 102c. The serving gateway 164 may also perform other functions, such as anchoring user planes during inter-eNode B handovers, triggering paging when downlink data is available for the WTRUs 102a, 102b, and 102c, managing and storing contexts of the WTRUs 102a, 102b, and 102c, and the like.

The serving gateway 164 may also be connected to the PDN gateway 166, which may provide the WTRUs 102a, 102b, and 102c with access to packet-switched networks, such as the Internet 110, to facilitate communications between the WTRUs 102a, 102b, 102c, and IP-enabled devices.

The core network 107 may facilitate communications with other networks. For example, the core network 107 may provide the WTRUs 102a, 102b, and 102c with access to circuit-switched networks, such as the PSTN 108, to facilitate communications between the WTRUs 102a, 102b, and 102c and traditional land-line communications devices. For example, the core network 107 may include, or may communicate with, an IP gateway (e.g., an IP Multimedia Subsystem (IMS) server) that serves as an interface between the core network 107 and the PSTN 108. In addition, the core network 107 may provide the WTRUs 102a, 102b, and 102c with access to the networks 112, which may include other wired or wireless networks that are owned and/or operated by other service providers.

FIG. 10D is a system diagram of an example RAN 105 and core network 109. The RAN 105 may employ an NR radio technology to communicate with the WTRUs 102a and 102b over the air interface 117. The RAN 105 may also be in communication with the core network 109. A Non-3GPP Interworking Function (N3IWF) 199 may employ a non-3GPP radio technology to communicate with the WTRU 102c over the air interface 198. The N3IWF 199 may also be in communication with the core network 109.

The RAN 105 may include gNode-Bs 180a and 180b. It will be appreciated that the RAN 105 may include any number of gNode-Bs. The gNode-Bs 180a and 180b may each include one or more transceivers for communicating with the WTRUs 102a and 102b over the air interface 117. When integrated access and backhaul connection are used, the same air interface may be used between the WTRUs and gNode-Bs, which may be the core network 109 via one or multiple gNBs. The gNode-Bs 180a and 180b may implement MIMO, MU-MIMO, and/or digital beamforming technology. Thus, the gNode-B 180a, for example, may use multiple antennas to transmit wireless signals to, and receive wireless signals from, the WTRU 102a. It should be appreciated that the RAN 105 may employ of other types of base stations such as an eNode-B. It will also be appreciated the RAN 105 may employ more than one type of base station. For example, the RAN may employ eNode-Bs and gNode-Bs.

The N3IWF 199 may include a non-3GPP Access Point 180c. It will be appreciated that the N3IWF 199 may include any number of non-3GPP Access Points. The non-3GPP Access Point 180c may include one or more transceivers for communicating with the WTRUs 102c over the air interface 198. The non-3GPP Access Point 180c may use the 802.11 protocol to communicate with the WTRU 102c over the air interface 198.

Each of the gNode-Bs 180a and 180b may be associated with a particular cell (not shown) and may be configured to handle radio resource management decisions, handover decisions, scheduling of users in the uplink and/or downlink, and the like. As shown in FIG. 10D, the gNode-Bs 180a and 180b may communicate with one another over an Xn interface, for example.

The core network 109 shown in FIG. 10D may be a 5G core network (5GC). The core network 109 may offer numerous communication services to customers who are interconnected by the radio access network. The core network 109 comprises a number of entities that perform the functionality of the core network. As used herein, the term “core network entity” or “network function” refers to any entity that performs one or more functionalities of a core network. It is understood that such core network entities may be logical entities that are implemented in the form of computer-executable instructions (software) stored in a memory of, and executing on a processor of, an apparatus configured for wireless and/or network communications or a computer system, such as system 90 illustrated in FIG. 10G.

In the example of FIG. 10D, the 5G Core Network 109 may include an access and mobility management function (AMF) 172, a Session Management Function (SMF) 174, User Plane Functions (UPFs) 176a and 176b, a User Data Management Function (UDM) 197, an Authentication Server Function (AUSF) 190, a Network Exposure Function (NEF) 196, a Policy Control Function (PCF) 184, a Non-3GPP Interworking Function (N3IWF) 199, a User Data Repository (UDR) 178. While each of the foregoing elements are depicted as part of the 5G core network 109, it will be appreciated that any one of these elements may be owned and/or operated by an entity other than the core network operator. It will also be appreciated that a 5G core network may not consist of all of these elements, may consist of additional elements, and may consist of multiple instances of each of these elements. FIG. 10D shows that network functions directly connect to one another, however, it should be appreciated that they may communicate via routing agents such as a diameter routing agent or message buses.

In the example of FIG. 10D, connectivity between network functions is achieved via a set of interfaces, or reference points. It will be appreciated that network functions could be modeled, described, or implemented as a set of services that are invoked, or called, by other network functions or services. Invocation of a Network Function service may be achieved via a direct connection between network functions, an exchange of messaging on a message bus, calling a software function, etc.

The AMF 172 may be connected to the RAN 105 via an N2 interface and may serve as a control node. For example, the AMF 172 may be responsible for registration management, connection management, reachability management, access authentication, access authorization. The AMF may be responsible forwarding user plane tunnel configuration information to the RAN 105 via the N2 interface. The AMF 172 may receive the user plane tunnel configuration information from the SMF via an N11 interface. The AMF 172 may generally route and forward NAS packets to/from the WTRUs 102a, 102b, and 102c via an N1 interface. The N1 interface is not shown in FIG. 10D.

The SMF 174 may be connected to the AMF 172 via an N11 interface. Similarly the SMF may be connected to the PCF 184 via an N7 interface, and to the UPFs 176a and 176b via an N4 interface. The SMF 174 may serve as a control node. For example, the SMF 174 may be responsible for Session Management, IP address allocation for the WTRUs 102a, 102b, and 102c, management and configuration of traffic steering rules in the UPF 176a and UPF 176b, and generation of downlink data notifications to the AMF 172.

The UPF 176a and UPF 176b may provide the WTRUs 102a, 102b, and 102c with access to a Packet Data Network (PDN), such as the Internet 110, to facilitate communications between the WTRUs 102a, 102b, and 102c and other devices. The UPF 176a and UPF 176b may also provide the WTRUs 102a, 102b, and 102c with access to other types of packet data networks. For example, Other Networks 112 may be Ethernet Networks or any type of network that exchanges packets of data. The UPF 176a and UPF 176b may receive traffic steering rules from the SMF 174 via the N4 interface. The UPF 176a and UPF 176b may provide access to a packet data network by connecting a packet data network with an N6 interface or by connecting to each other and to other UPFs via an N9 interface. In addition to providing access to packet data networks, the UPF 176 may be responsible packet routing and forwarding, policy rule enforcement, quality of service handling for user plane traffic, downlink packet buffering.

The AMF 172 may also be connected to the N3IWF 199, for example, via an N2 interface. The N3IWF facilitates a connection between the WTRU 102c and the 5G core network 170, for example, via radio interface technologies that are not defined by 3GPP. The AMF may interact with the N3IWF 199 in the same, or similar, manner that it interacts with the RAN 105.

The PCF 184 may be connected to the SMF 174 via an N7 interface, connected to the AMF 172 via an N15 interface, and to an Application Function (AF) 188 via an N5 interface. The N15 and N5 interfaces are not shown in FIG. 10D. The PCF 184 may provide policy rules to control plane nodes such as the AMF 172 and SMF 174, allowing the control plane nodes to enforce these rules. The PCF 184, may send policies to the AMF 172 for the WTRUs 102a, 102b, and 102c so that the AMF may deliver the policies to the WTRUs 102a, 102b, and 102c via an N1 interface. Policies may then be enforced, or applied, at the WTRUs 102a, 102b, and 102c.

The UDR 178 may act as a repository for authentication credentials and subscription information. The UDR may connect to network functions, so that network function can add to, read from, and modify the data that is in the repository. For example, the UDR 178 may connect to the PCF 184 via an N36 interface. Similarly, the UDR 178 may connect to the NEF 196 via an N37 interface, and the UDR 178 may connect to the UDM 197 via an N35 interface.

The UDM 197 may serve as an interface between the UDR 178 and other network functions. The UDM 197 may authorize network functions to access of the UDR 178. For example, the UDM 197 may connect to the AMF 172 via an N8 interface, the UDM 197 may connect to the SMF 174 via an N10 interface. Similarly, the UDM 197 may connect to the AUSF 190 via an N13 interface. The UDR 178 and UDM 197 may be tightly integrated.

The AUSF 190 performs authentication related operations and connects to the UDM 178 via an N13 interface and to the AMF 172 via an N12 interface.

The NEF 196 exposes capabilities and services in the 5G core network 109 to Application Functions (AF) 188. Exposure may occur on the N33 API interface. The NEF may connect to an AF 188 via an N33 interface and it may connect to other network functions in order to expose the capabilities and services of the 5G core network 109.

Application Functions 188 may interact with network functions in the 5G Core Network 109. Interaction between the Application Functions 188 and network functions may be via a direct interface or may occur via the NEF 196. The Application Functions 188 may be considered part of the 5G Core Network 109 or may be external to the 5G Core Network 109 and deployed by enterprises that have a business relationship with the mobile network operator.

Network Slicing is a mechanism that could be used by mobile network operators to support one or more ‘virtual’ core networks behind the operator's air interface. This involves ‘slicing’ the core network into one or more virtual networks to support different RANs or different service types running across a single RAN. Network slicing enables the operator to create networks customized to provide optimized solutions for different market scenarios which demands diverse requirements, e.g. in the areas of functionality, performance and isolation.

3GPP has designed the 5G core network to support Network Slicing. Network Slicing is a good tool that network operators can use to support the diverse set of 5G use cases (e.g., massive IoT, critical communications, V2X, and enhanced mobile broadband) which demand very diverse and sometimes extreme requirements. Without the use of network slicing techniques, it is likely that the network architecture would not be flexible and scalable enough to efficiently support a wider range of use cases need when each use case has its own specific set of performance, scalability, and availability requirements. Furthermore, introduction of new network services should be made more efficient.

Referring again to FIG. 10D, in a network slicing scenario, a WTRU 102a, 102b, or 102c may connect to an AMF 172, via an N1 interface. The AMF may be logically part of one or more slices. The AMF may coordinate the connection or communication of WTRU 102a, 102b, or 102c with one or more UPF 176a and 176b, SMF 174, and other network functions. Each of the UPFs 176a and 176b, SMF 174, and other network functions may be part of the same slice or different slices. When they are part of different slices, they may be isolated from each other in the sense that they may utilize different computing resources, security credentials, etc.

The core network 109 may facilitate communications with other networks. For example, the core network 109 may include, or may communicate with, an IP gateway, such as an IP Multimedia Subsystem (IMS) server, that serves as an interface between the 5G core network 109 and a PSTN 108. For example, the core network 109 may include, or communicate with a short message service (SMS) service center that facilities communication via the short message service. For example, the 5G core network 109 may facilitate the exchange of non-IP data packets between the WTRUs 102a, 102b, and 102c and servers or applications functions 188. In addition, the core network 170 may provide the WTRUs 102a, 102b, and 102c with access to the networks 112, which may include other wired or wireless networks that are owned and/or operated by other service providers.

The core network entities described herein and illustrated in FIGS. 10A, 10C, 10D, and 10E are identified by the names given to those entities in certain existing 3GPP specifications, but it is understood that in the future those entities and functionalities may be identified by other names and certain entities or functions may be combined in future specifications published by 3GPP, including future 3GPP NR specifications. Thus, the particular network entities and functionalities described and illustrated in FIGS. 10A, 10B, 10C, 10D, and 10E are provided by way of example only, and it is understood that the subject matter disclosed and claimed herein may be embodied or implemented in any similar communication system, whether presently defined or defined in the future.

FIG. 10E illustrates an example communications system 111 in which the systems, methods, apparatuses described herein may be used. Communications system 111 may include Wireless Transmit/Receive Units (WTRUs) A, B, C, D, E, F, a base station gNB 121, a V2X server 124, and Road Side Units (RSUs) 123a and 123b. In practice, the concepts presented herein may be applied to any number of WTRUs, base station gNBs, V2X networks, and/or other network elements. One or several or all WTRUs A, B, C, D, E, and F may be out of range of the access network coverage 131. WTRUs A, B, and C form a V2X group, among which WTRU A is the group lead and WTRUs B and C are group members.

WTRUs A, B, C, D, E, and F may communicate with each other over a Uu interface 129 via the gNB 121 if they are within the access network coverage 131. In the example of FIG. 10E, WTRUs B and F are shown within access network coverage 131. WTRUs A, B, C, D, E, and F may communicate with each other directly via a Sidelink interface (e.g., PC5 or NR PC5) such as interface 125a, 125b, or 128, whether they are under the access network coverage 131 or out of the access network coverage 131. For instance, in the example of FIG. 10E, WRTU D, which is outside of the access network coverage 131, communicates with WTRU F, which is inside the coverage 131.

WTRUs A, B, C, D, E, and F may communicate with RSU 123a or 123b via a Vehicle-to-Network (V2N) 133 or Sidelink interface 125b. WTRUs A, B, C, D, E, and F may communicate to a V2X Server 124 via a Vehicle-to-Infrastructure (V2I) interface 127. WTRUs A, B, C, D, E, and F may communicate to another UE via a Vehicle-to-Person (V2P) interface 128.

FIG. 10F is a block diagram of an example apparatus or device WTRU 102 that may be configured for wireless communications and operations in accordance with the systems, methods, and apparatuses described herein, such as a WTRU 102 of FIG. 10A, 10B, 10C, 10D, or 10E. As shown in FIG. 10F, the example WTRU 102 may include a processor 118, a transceiver 120, a transmit/receive element 122, a speaker/microphone 124, a keypad 126, a display/touchpad/indicators 128, non-removable memory 130, removable memory 132, a power source 134, a global positioning system (GPS) chipset 136, and other peripherals 138. It will be appreciated that the WTRU 102 may include any sub-combination of the foregoing elements. Also, the base stations 114a and 114b, and/or the nodes that base stations 114a and 114b may represent, such as but not limited to transceiver station (BTS), a Node-B, a site controller, an access point (AP), a home node-B, an evolved home node-B (eNodeB), a home evolved node-B (HeNB), a home evolved node-B gateway, a next generation node-B (gNode-B), and proxy nodes, among others, may include some or all of the elements depicted in FIG. 10F and described herein.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Array (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 10F depicts the processor 118 and the transceiver 120 as separate components, it will be appreciated that the processor 118 and the transceiver 120 may be integrated together in an electronic package or chip.

The transmit/receive element 122 of a UE may be configured to transmit signals to, or receive signals from, a base station (e.g., the base station 114a of FIG. 10A) over the air interface 115/116/117 or another UE over the air interface 115d/116d/117d. For example, the transmit/receive element 122 may be an antenna configured to transmit and/or receive RF signals. The transmit/receive element 122 may be an emitter/detector configured to transmit and/or receive IR, UV, or visible light signals, for example. The transmit/receive element 122 may be configured to transmit and receive both RF and light signals. It will be appreciated that the transmit/receive element 122 may be configured to transmit and/or receive any combination of wireless or wired signals.

In addition, although the transmit/receive element 122 is depicted in FIG. 10F as a single element, the WTRU 102 may include any number of transmit/receive elements 122. More specifically, the WTRU 102 may employ MIMO technology. Thus, the WTRU 102 may include two or more transmit/receive elements 122 (e.g., multiple antennas) for transmitting and receiving wireless signals over the air interface 115/116/117.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, for example NR and IEEE 802.11 or NR and E-UTRA, or to communicate with the same RAT via multiple beams to different RRHs, TRPs, RSUs, or nodes.

The processor 118 of the WTRU 102 may be coupled to, and may receive user input data from, the speaker/microphone 124, the keypad 126, and/or the display/touchpad/indicators 128 (e.g., a liquid crystal display (LCD) display unit or organic light-emitting diode (OLED) display unit. The processor 118 may also output user data to the speaker/microphone 124, the keypad 126, and/or the display/touchpad/indicators 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. The processor 118 may access information from, and store data in, memory that is not physically located on the WTRU 102, such as on a server that is hosted in the cloud or in an edge computing platform or in a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries, solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 115/116/117 from a base station (e.g., base stations 114a, 114b) and/or determine its location based on the timing of the signals being received from two or more nearby base stations. It will be appreciated that the WTRU 102 may acquire location information by way of any suitable location-determination method.

The processor 118 may further be coupled to other peripherals 138, which may include one or more software and/or hardware modules that provide additional features, functionality, and/or wired or wireless connectivity. For example, the peripherals 138 may include various sensors such as an accelerometer, biometrics (e.g., finger print) sensors, an e-compass, a satellite transceiver, a digital camera (for photographs or video), a universal serial bus (USB) port or other interconnect interfaces, a vibration device, a television transceiver, a hands free headset, a Bluetooth® module, a frequency modulated (FM) radio unit, a digital music player, a media player, a video game player module, an Internet browser, and the like.

The WTRU 102 may be included in other apparatuses or devices, such as a sensor, consumer electronics, a wearable device such as a smart watch or smart clothing, a medical or eHealth device, a robot, industrial equipment, a drone, a vehicle such as a car, truck, train, or an airplane. The WTRU 102 may connect to other components, modules, or systems of such apparatuses or devices via one or more interconnect interfaces, such as an interconnect interface that may comprise one of the peripherals 138.

FIG. 10G is a block diagram of an exemplary computing system 90 in which one or more apparatuses of the communications networks illustrated in FIGS. 10A, 10C, 10D and 10E may be embodied, such as certain nodes or functional entities in the RAN 103/104/105, Core Network 106/107/109, PSTN 108, Internet 110, Other Networks 112, or Network Services 113. Computing system 90 may comprise a computer or server and may be controlled primarily by computer readable instructions, which may be in the form of software, wherever, or by whatever means such software is stored or accessed. Such computer readable instructions may be executed within a processor 91, to cause computing system 90 to do work. The processor 91 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Array (FPGAs) circuits, any other type of integrated circuit (IC), a state machine, and the like. The processor 91 may perform signal coding, data processing, power control, input/output processing, and/or any other functionality that enables the computing system 90 to operate in a communications network. Coprocessor 87 is an optional processor, distinct from main processor 91, that may perform additional functions or assist processor 91. Processor 91 and/or coprocessor 87 may receive, generate, and process data related to the methods and apparatuses disclosed herein.

In operation, processor 91 fetches, decodes, and executes instructions, and transfers information to and from other resources via the computing system's main data-transfer path, system bus 99. Such a system bus connects the components in computing system 90 and defines the medium for data exchange. System bus 99 typically includes data lines for sending data, address lines for sending addresses, and control lines for sending interrupts and for operating the system bus. An example of such a system bus 99 is the PCI (Peripheral Component Interconnect) bus.

Memories coupled to system bus 99 include random access memory (RAM) 98 and read only memory (ROM) 93. Such memories include circuitry that allows information to be stored and retrieved. ROMs 93 generally contain stored data that cannot easily be modified. Data stored in RAM 98 may be read or changed by processor 91 or other hardware devices. Access to RAM 98 and/or ROM 93 may be controlled by memory controller 92. Memory controller 92 may provide an address translation function that translates virtual addresses into physical addresses as instructions are executed. Memory controller 92 may also provide a memory protection function that isolates processes within the system and isolates system processes from user processes. Thus, a program running in a first mode may access only memory mapped by its own process virtual address space; it cannot access memory within another process's virtual address space unless memory sharing between the processes has been set up.

In addition, computing system 90 may contain peripherals controller 88 responsible for communicating instructions from processor 91 to peripherals, such as printer 94, keyboard 89, mouse 95, and disk drive 85.

Display 86, which is controlled by display controller 96, is used to display visual output generated by computing system 90. Such visual output may include text, graphics, animated graphics, and video. The visual output may be provided in the form of a graphical user interface (GUI). Display 86 may be implemented with a CRT-based video display, an LCD-based flat-panel display, gas plasma-based flat-panel display, or a touch-panel. Display controller 96 includes electronic components required to generate a video signal that is sent to display 86.

Further, computing system 90 may contain communication circuitry, such as for example a wireless or wired network adapter 97, that may be used to connect computing system 90 to an external communications network or devices, such as the RAN 103/104/105, Core Network 106/107/109, PSTN 108, Internet 110, WTRUs 102, or Other Networks 112 of FIGS. 10A, 10B, 10C, 10D, and 10E, to enable the computing system 90 to communicate with other nodes or functional entities of those networks. The communication circuitry, alone or in combination with the processor 91, may be used to perform the transmitting and receiving steps of certain apparatuses, nodes, or functional entities described herein.

It is understood that any or all of the apparatuses, systems, methods and processes described herein may be embodied in the form of computer executable instructions (e.g., program code) stored on a computer-readable storage medium which instructions, when executed by a processor, such as processors 118 or 91, cause the processor to perform and/or implement the systems, methods and processes described herein. Specifically, any of the steps, operations, or functions described herein may be implemented in the form of such computer executable instructions, executing on the processor of an apparatus or computing system configured for wireless and/or wired network communications. Computer readable storage media includes volatile and nonvolatile, removable and non-removable media implemented in any non-transitory (e.g., tangible or physical) method or technology for storage of information, but such computer readable storage media do not include signals. Computer readable storage media include, but are not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other tangible or physical medium which may be used to store the desired information and which may be accessed by a computing system.

1. An apparatus comprising a processor, a memory, and communication circuitry, the apparatus being connected to a network via its communication circuitry, the apparatus further comprising computer-executable instructions stored in the memory of the apparatus which, when executed by the processor of the apparatus, cause the apparatus to perform operations comprising:
sending, to a second apparatus, a first message comprising a first identifier for a third apparatus to enable the third apparatus to receive the first message;
receiving, from the second apparatus, a second message comprising a second identifier of the third apparatus; and
sending, to the third apparatus, a third message comprising the second identifier.

2. The apparatus of claim 1, wherein the apparatus comprises at least one of a user equipment (UE), a wireless communications device, a computing device, a smartphone, or a gateway.

3. The apparatus of claim 1, wherein the second apparatus comprises a network function.

4. The apparatus of claim 3, wherein the network function comprises an access and management function (AMF).

5. The apparatus of claim 1, wherein the third apparatus comprises at least one of a user equipment (UE) or an Internet of Things (IoT) server.

6. (canceled)

7. The apparatus of claim 1, wherein the first identifier comprises an external public identifier of the third apparatus.

8. The apparatus of claim 1, wherein the second identifier comprises at least one of a 5G Globally Unique Temporary Identifier, a 5G Temporary Mobile Subscriber Identity (5G-TMSI), or a hashed version of a 5G Temporary Mobile Subscriber Identity (5G-TMSI).

9. The apparatus of claim 1, wherein the second message further comprises an acknowledgment message.

10-11. (canceled)

12. The apparatus of claim 1, further comprising computer-executable instructions stored in the memory of the apparatus which, when executed by the processor of the apparatus, cause the apparatus to perform further operations comprising:
receiving, from the second apparatus, a fourth message indicating that the second identifier has changed.

13. The apparatus of claim 12, wherein the fourth message comprises a non-access stratum notification.

14. The apparatus of claim 12, wherein the fourth message is based on a location change of the third apparatus.

15. The apparatus of claim 1, further comprising computer-executable instructions stored in the memory of the apparatus which, when executed by the processor of the apparatus, cause the apparatus to perform further operations comprising:
sending, to the second apparatus, a fifth message comprising a group identifier for a group of apparatuses.

16. The apparatus of claim 15, wherein the group identifier comprises a globally unique AMF identifier (GUAMI).

17. The apparatus of claim 1, wherein a protocol data unit (PDU) session is established prior to sending the first message.

18. The apparatus of claim 17, wherein the third apparatus is identified as a session endpoint in the PDU session establishment procedure.

19. The apparatus of claim 1, wherein the first message further comprises an acknowledgement preference.

20. The apparatus of claim 1, wherein the third message further comprises an acknowledgement preference.

21-24. (canceled)

25. A method comprising:
sending, to an apparatus, a first message comprising a first identifier for a second apparatus to enable the second apparatus to receive the first message;
receiving, from the apparatus, a second message comprising a second identifier of the second apparatus; and
sending, to the second apparatus, a third message comprising the second identifier.

26. The method of claim 25, wherein the apparatus comprises a network function, wherein the network function comprises an access and management function (AMF).

27. (canceled)

28. The method of claim 25, wherein the second apparatus comprises at least one of a user equipment (UE) or an Internet of Things (IoT) server.

29-43. (canceled)
